(19) United States
(12) Patent Application Publication
(10) Pub. No.: US 2026/0252725 A1
(43) Pub. Date: Aug. 27, 2026

(54) IDENTITY-VERIFIED ARTICLE-LINKED CLOUD CONTENT ACCESS AND MANAGEMENT SYSTEM

(71) Applicant: WuzEpic LLC, Phoenix, AZ (US)

(72) Inventors: Paul R. Penney, Phoenix, AZ (US); Brian M. Hickie, Phoenix, AZ (US)

(73) Assignee: WuzEpic LLC, Phoenix, AZ (US)

(21) Appl. No.: 19/550,062

(22) Filed: Feb. 25, 2026

Related U.S. Application Data
(60) Provisional application No. 63/989,986, filed on Feb. 24, 2026.
(60) Provisional application No. 63/763,097, filed on Feb. 25, 2025.

(51) Int. Cl. G06F 21/62; G06F 21/32; G06V 40/16

(52) U.S. Cl. CPC G06F 21/6218; G06F 21/32; G06V 40/172; G06F 2221/2141

(57) ABSTRACT

A method for controlling access to content representations. The method comprises generating the content representations based on metadata and spatial indicators related to content source. The method further comprises receiving an access indicator corresponding to a request to access the content representations. The method further comprises correlating the access indicator with the spatial indicators. Further, the method comprises identifying a candidate and retrieving registration parameters. The method further comprises validating the candidate and authorizing access to the content representations. The method further comprises generating an admission credential in response to authorizing access. Thereafter, the method comprises enabling access to the set of content representations using the admission credential.

### PRIORITY

This application is a non-provisional of and claims priority to U.S. Provisional Patent Application Nos. 63/763,097, filed February 25, 2025, and 63/989,986, filed February 24, 2026, the contents of which are hereby incorporated by reference in their entirety for all purposes.

### FIELD OF DISCLOSURE

The present disclosure relates to an Artificial Intelligence (AI)-enabled system that generates and manages content representations for a content source. The present disclosure further relates to identity-based access control of digital content associated with the content source.

### BACKGROUND

Attendees at events, such as sporting events or concerts, often desire to remember some moments of the event. Nowadays, the attendees take photographs of themselves and/or participants at the event for such a purpose. The photographs can be associated with the attendees with a background representative of the location or venue of the event.

However, the photographs do not provide an immersive experience of the event. For example, the photographs do not provide an event attendee with images of participants in action or performing during the event, or integrated media captured from multiple perspectives during the event, and images of the attendees and their family and friends. Further, these photographs cannot reflect the customer's attendance at the event, particularly, where the customer is a viewer of a sporting event, such as a football game. Furthermore, these photographs cannot be personalized according to the attendee’s input using automated or intelligent processing techniques. In addition, these photographs cannot be authenticated or securely linked to a verified user profile, as they are not associated with a certificate of authenticity. Further, existing photographs and framed media lack any mechanism for digitally linking a physical display of the event to a corresponding collection of digital event media captured during the event.

### SUMMARY

In one embodiment, the present disclosure eliminates the drawbacks of the traditional content distribution and access control mechanisms by introducing a new system to streamline the interaction with the systems. Attendees find their preferred content seamlessly.

A method for controlling access to content representations. The method comprises generating the content representations based on metadata and spatial indicators related to content source. The method further comprises receiving an access indicator corresponding to a request to access the content representations. The method further comprises correlating the access indicator with the spatial indicators. Further, the method comprises identifying a candidate and retrieving registration parameters. The method further comprises validating the candidate and authorizing access to the content representations. The method further comprises generating an admission credential in response to authorizing access. Thereafter, the method comprises enabling access to the set of content representations using the admission credential.

A computer-implemented method for controlling access to a set of content representations based on identity verification. The method comprises generating, via one or more processors, the set of content representations based on metadata related to a content source and a plurality of spatial indicators corresponding to locations related to the content source. The metadata includes tagged descriptors corresponding to the content source. The method further comprises receiving an access indicator corresponding to a request to access the set of content representations. The set of content representations are stored in a cloud-based content repository. The method further comprises correlating the access indicator with at least one of the plurality of spatial indicators. Further, the method comprises identifying a candidate based on the correlation. The method further comprises retrieving registration parameters associated with the candidate. The method further comprises validating the candidate using a machine-learning model configured to evaluate visual features and contextual attributes associated with the candidate. Further, the method comprises authorizing access to the set of content representations based on the validation of the candidate and the registration parameters. Further, the method comprises generating an admission credential in response to authorizing the access. Thereafter, the method comprises enabling access to the set of content representations using the admission credential.

A system for controlling access to a set of content representations based on identity verification. The system comprises a cloud-based content repository storing the set of content representations. The system further comprises one or more processors operationally coupled to the cloud-based content repository. The one or more processors are configured to generate the set of content representations based on metadata related to a content source and a plurality of spatial indicators corresponding to locations related to the content source. The metadata includes tagged descriptors corresponding to the content source. The one or more processors are further configured to receive an access indicator corresponding to a request to access the set of content representations. The set of content representations are stored in a cloud-based content repository. The one or more processors are further configured to correlate the access indicator with at least one of the plurality of spatial indicators. Further, the one or more processors are configured to identify a candidate based on the correlation. The one or more processors are configured to retrieve registration parameters associated with the candidate. The one or more processors are further configured to validate the candidate using a machine-learning model configured to evaluate visual features and contextual attributes associated with the candidate. Further, the one or more processors are configured to authorize access to the set of content representations based on the validation of the candidate and the registration parameters. Further, the one or more processors are configured to generate an admission credential in response to authorizing the access. Thereafter, the one or more processors are configured to enable access to the set of content representations using the admission credential.

A non-transitory computer-readable medium storing instructions that, when executed by one or more processors, cause the one or more processors to perform a method for controlling access to a set of content representations based on identity verification. The method comprises generating, via one or more processors, the set of content representations based on metadata related to a content source and a plurality of spatial indicators corresponding to locations related to the content source. The metadata includes tagged descriptors corresponding to the content source. The method further comprises receiving an access indicator corresponding to a request to access the set of content representations. The set of content representations are stored in a cloud-based content repository. The method further comprises correlating the access indicator with at least one of the plurality of spatial indicators. Further, the method comprises identifying a candidate based on the correlation. The method further comprises retrieving registration parameters associated with the candidate. The method further comprises validating the candidate using a machine-learning model configured to evaluate visual features and contextual attributes associated with the candidate. Further, the method comprises authorizing access to the set of content representations based on the validation of the candidate and the registration parameters. Further, the method comprises generating an admission credential in response to authorizing the access. Thereafter, the method comprises enabling access to the set of content representations using the admission credential.

This summary is a high-level overview of various aspects of the disclosure and introduces some of the concepts that are further described in the detailed description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

The term embodiment and like terms are intended to refer broadly to all the subject matter of this disclosure and the claims below. Statements containing these terms should be understood not to limit the subject matter described herein or to limit the meaning or scope of the claims below. Embodiments of the present disclosure covered herein are defined by the claims below, not this summary.

Certain embodiments of the present disclosure described herein relate to systems and methods that enhance and efficiently implement ticket booking process for events. Certain aspects and features of the present disclosure relate to a system of one or more computers can be configured to perform operations or actions by virtue of having software, firmware, hardware, or a combination of them installed on the system that in operation causes or causes the system to perform the actions.

One or more computer programs can be configured to perform operations or actions by virtue of including instructions that, when executed by data processing apparatus, cause the apparatus to perform the actions. One general aspect includes a multi-modal e-commerce system. The multi-modal e-commerce system also includes a multi-modal application for ticket booking and a hybrid interface, where the hybrid interface includes a first interface and a second interface.

### BRIEF DESCRIPTION OF THE DRAWINGS

The present disclosure is described in conjunction with the appended figures:

FIG. 1 illustrates a block diagram of a content access and management system according to an embodiment of the present disclosure;

FIG. 2 illustrates a block diagram of a user device and an application interface for interacting with a user according to an embodiment of the present disclosure;

FIG. 3 illustrates a block diagram of the user device according to an embodiment of the present disclosure;

FIG. 4 illustrates a block diagram of a content processing system according to an embodiment of the present disclosure;

FIG. 5 illustrates a block diagram of a machine learning (ML) model according to an embodiment of the present disclosure;

FIG. 6 illustrates a block diagram of an identifier manager according to an embodiment of the present disclosure;

FIG. 7 illustrates a block diagram of an access controller according to an embodiment of the present disclosure;

FIGS. 8A-8G illustrate an example embodiment of an interface diagram of the application interface generated by the content processing system according to an embodiment of the present disclosure;

FIGS. 8H-8K illustrate exemplary frames created by the content processing system according to an embodiment of the present disclosure;

FIG. 9 illustrates a flowchart for creating customized content representations related to a content source according to an embodiment of the present disclosure;

FIG. 10 illustrates a block diagram of the ML model(s) according to an embodiment of the present disclosure;

FIG. 11 illustrates a flowchart for selecting content representations related to the content source for the user according to an embodiment of the present disclosure;

FIG. 12 illustrates a block diagram illustrating the formation of a digital twin of the user according to an embodiment of the present disclosure;

FIG. 13 illustrates a flowchart for creating a virtual frame according to an embodiment of the present disclosure;

FIG. 14 illustrates a frame having images of a particular occasion according to an embodiment of the present disclosure;

FIG. 15 illustrates a flowchart for providing the virtual frame to the user according to an embodiment of the present disclosure;

FIG. 16 illustrates a flowchart for managing cost to a user against content representations related to the content source according to an embodiment of the present disclosure;

FIG. 17 illustrates a flowchart for providing a package to the user according to an embodiment of the present disclosure;

FIG. 18 illustrates a flowchart for controlling access to a content repository according to an embodiment of the present disclosure; and

FIG. 19 illustrates a flowchart for controlling access to the content representations based on identity verification according to an embodiment of the present disclosure.

In the appended figures, similar components and/or features may have the same reference label. Further, various components of the same type may be distinguished by following the reference label with a second alphabetical label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

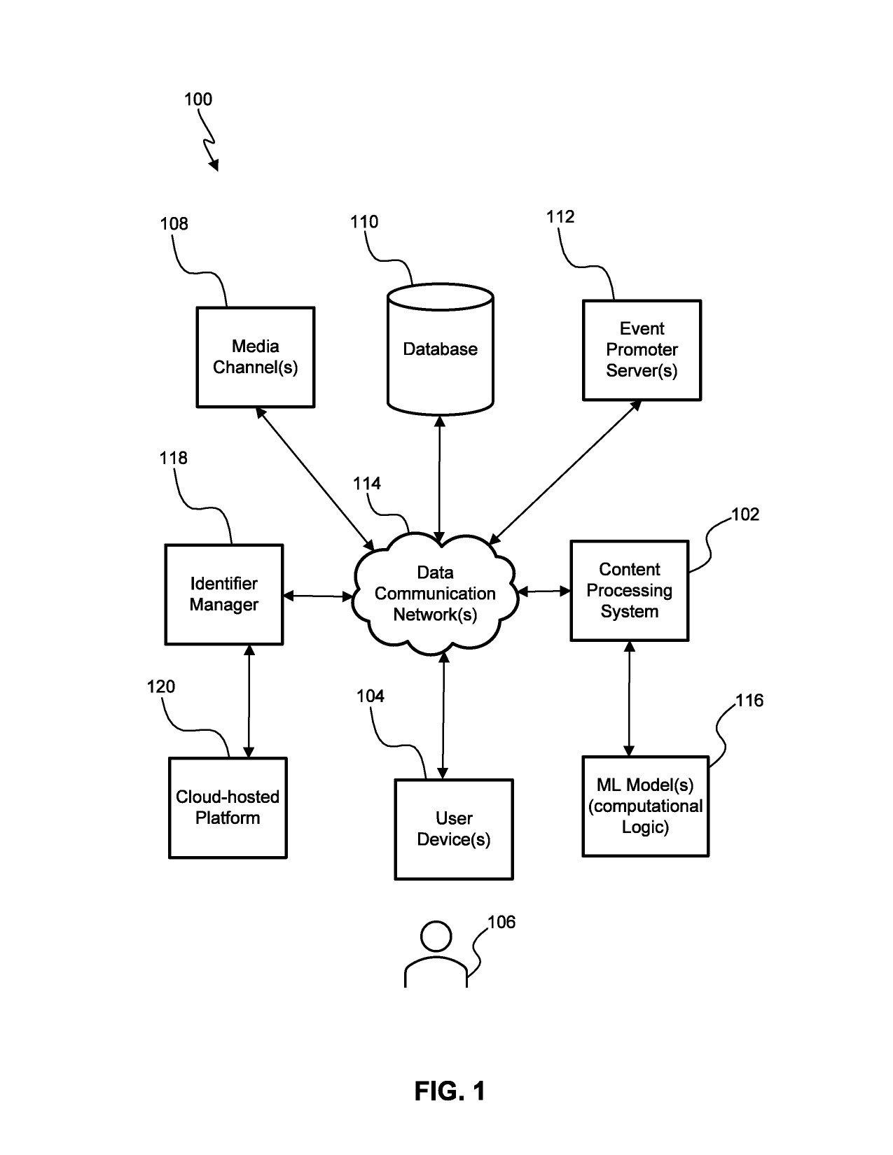

Referring to FIG. 1, a block diagram of a content access and management system 100 is shown. The content access and management system 100 corresponds to an identity-verified, article-linked cloud content access system. The content access and management system 100 generates, stores, correlates, controls and manages access to a set of content representations associated with a content source based on identity verification. As described in further detail herein, the content access and management system 100 comprises a content processing system 102, a user device(s) 104 associated with a user 106, media channel(s) 108, a database 110, an event promoter server(s) 112, data communication network(s) 114, machine learning (ML) models 116, an identifier manager 118, and a cloud-hosted platform 120 maintaining a cloud-based content repository. The terms “user device(s)” and user device” are used interchangeably throughout this disclosure.

In one exemplary embodiment of the present disclosure, the content processing system 102 is communicatively coupled with the user device 104, the media channel(s) 108, the database 110, the event promoter server(s) 112, the identifier manager 118, and the cloud-hosted platform 120 over the data communication network(s) 114 to enable generation of the content representations, correlation with spatial indicators, identity validation, admission credential generation, cryptographic association, and controlled access management of the content representations. The content representations are stored in a cloud-based content repository. The cloud-based content repository corresponds to a digital bucket maintained for a subscribed profile or a registered profile corresponding to a candidate or a user 106. The content representations correspond to digital assets. Further, the set of content representations comprises at least one of images, videos, and professional photographs captured at the content source. The content processing system 102 may include a customized media creation system. In some embodiments, the content processing system 102 is not limited to content creation but further performs identity-based access control, candidate identification, and admission credential management.

In another embodiment, the content processing system 102 may include the database 110. In another embodiment, the user device 104 may include a user database. Please note that the specification is not limited to a single-user device. It may communicate with multiple user devices either individually or simultaneously.

The content processing system 102 receives information from multiple sources, such as the media channel(s) 108, the database 110, the user database, and a database related to the event promoter server(s) 112. The information received includes metadata related to the content source and a plurality of spatial indicators corresponding to locations associated with the content source. The content processing system 102 processes the metadata and the spatial indicators to generate the content representations. Further, the content processing system 102 receives an access indicator corresponding to a request to access the content representations. Upon receiving the access indicator, the identifier manager 118 correlates the access indicator with at least one of the spatial indicators to identify a candidate associated with the access request. The information received may be provided to the ML model(s) 116 to identify candidates who have attended the content source, such as a sporting event or a concert. The content source can be interchangeably termed as an event. The ML model(s) 116 are trained on data related to identifying a person from an image or a photo.

In some embodiments, the candidates can be interchangeably termed as users. Registration or subscription parameters associated with the identified candidate are retrieved from the cloud-based content repository or associated databases. After identifying the users who have attended the event, the content processing system 102 utilizes the information to suggest multiple options for the identified users. The options may indicate different items, content, or articles to be purchased by the user 106. Further, the options correspond to customization parameters associated with personalized content generation or merchandise generation. In some embodiments, to enable identity verification, the ML model(s) 116 are configured to evaluate visual features associated with the candidate and contextual attributes associated with the candidate. The visual features may include facial characteristics extracted from images, photos or content representations associated with the access indicator. The contextual attributes may include at least one of device metadata, geolocation data, time-of-access information, network identifiers, historical access activity, or spatial correlation data associated with the access indicator. The ML model(s) 116 validates the candidate based on the evaluated visual features and contextual attributes.

In one embodiment, the access indicator is generated in response to detection of an identifier placed on the article corresponding to the content source. The identifier may comprise at least one of a machine-readable code, a biometric input interface, or a facial recognition trigger. Scanning or detecting the identifier initiates an access request to the cloud-based content repository. The identifier may be visibly displayed on the article or, in some embodiments, may be embedded in a concealed, machine-readable, or digitally encoded form that is not readily visible to the human eye but is detectable by a compatible device or application.

In one embodiment, the ML model(s) 116 include a facial recognition model configured to extract visual features from a stored reference image associated with the candidate. The facial recognition model is further configured to extract visual features from at least one image associated with the access indicator. Further, the facial recognition model generates a similarity score. The admission credential is generated when the similarity score exceeds a predefined confidence threshold indicative of a verified identity match.

The identifier manager 118 evaluates the access indicator against a plurality of access policies. The access policies define one or more access conditions, including at least one of full access, limited access, time-restricted access, content-specific access, or denied access. Authorization is performed based on the evaluated access condition.

In some embodiments, social media-based authentication may be implemented to facilitate controlled access to the content representations. The content processing system 102 may interface with social media platforms associated with the user 106 to verify identity and retrieve relationship data, subject to user authorization. Based on information obtained from the social media platform, such as identified friends, family members, or approved connections, the content processing system 102 may determine whether a requesting individual satisfies the access policies.

Upon successful authorization, an admission credential is generated. The admission credential is cryptographically associated with the content representations, such that the admission credential represents a secure digital pointer to the cloud-based content repository. The admission credential enables secure retrieval of the content representations.

To provide the options to the users, the content processing system 102 generates an interface on the user device 104. The user device 104 may include several types of computing systems, such as Personal Assistant (PA) devices, portable handheld devices, general purpose computers (e.g., personal computers and laptops), workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems (OS), Linux or Linux-like OS, such as Google Chrome™ OS), including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head-mounted displays and other devices. Gaming systems may include various handheld gaming devices, Internet-enabled gaming devices (e.g., a Microsoft Xbox® gaming console with or absent a Kinect® gesture input device, Sony PlayStation® system, various gaming systems provided by Nintendo®, and others), and the like. The client devices may be capable of executing various applications, such as various Internet-related apps and communication applications (e.g., email applications, short message service (SMS) applications), and may use various communication protocols.

The user device 104 may render the interface to the user 106 for selecting an option from the multiple options related to the event for customizing content to be placed on a frame of an article. The article corresponds to an event-related article. The article can include the set of content representations. The set of content representations can include a digital asset or a physical asset. Further, the article includes the frame. The frame is an individualized frame and may have a mat portion. The set of content representations may include customized content. The customized content corresponds to individualized assets. The options for customizing the content representations may comprise a category of the event, a frame size, a frame color, a pattern or style of the frame, a color of mat to be present in the frame, customized content entered by the user 106, sponsored images, or photos, and/or the user’s images or photos. To generate the options, the content processing system 102 refers to data available on the media channel(s) 108, the database 110, and the event promoter server(s) 112. In some embodiments, access to the interface and the selectable options is conditioned upon successful identity verification and authorization through the admission credential generated by the identifier manager 118.

For example, the content processing system 102 obtains data related to the user 106 from the media channel(s) 108, such as social media, the user’s shared database, and digital containers associated with the user 106. Data related to the user 106 may indicate the user’s preferences, user characteristics, and Personally Identifiable Information (PII). Such data may be obtained subject to user consent and applicable data protection regulations. Further, the content processing system 102 obtains data related to the event from the event promoter server(s) 112. Data related to the event may comprise logos, players, teams, cost to the user/consumer, and royalties to Intellectual Property (IP) rights holders.

In addition, the content processing system 102 obtains the content representations related to the content source from the database 110, the user database, and/or the database related to the event promoter server(s) 112. The photos may comprise photos of the venue, photos of players, high-quality Getty images, landscape views of the ground, and so on. In an embodiment, the content processing system 102 may fetch the content representations from the user device 104. To fetch the content representations from the user device 104, the content processing system 102 may send a notification to the user device 104. The notification enables the user 106 to either allow access to the memory of the user device 104 to the content processing system 102 or refrain from accessing the memory. The content processing system 102 utilizes such data to determine multiple options to be rendered on the user device 104. In some embodiments, the fetched content representations are cryptographically linked to the verified identity of the user 106 and stored in the cloud-based content repository for controlled retrieval.

The content processing system 102 is communicatively coupled to the ML model(s) 116 (also referred to as model, data model(s), and/or computational logic). The ML model(s) 116 are trained on different datasets to predict the options to be presented to the user 106 according to the user’s preferences, the user characteristics, the PII, and information related to purchase history. The content processing system 102 may execute the ML model(s) 116 to determine the intent of the user 106 associated with the user device 104. Additionally, the content processing system 102 translates the user intent into actionable commands to generate the options personalized to the user 106 associated with the user device 104. In some embodiments, the ML model(s) 116 further cooperate with the identifier manager 118 to ensure that personalized options are presented merely upon successful authentication and satisfaction of predefined access policies.

In one exemplary embodiment of the present disclosure, the content processing system 102 obtains data related to a movement of the user 106 within the event from a positioning server, such as a global positioning system (GPS). The positioning server obtains a user location during the event. The ML model(s) 116 utilize data related to the movement of the user 106 to further personalize the content for the user 106. For example, if data related to the movement of user 106 indicates that the user 106 is moving in proximity to a dugout of a specific team in a football match, the ML model(s) 116 predict that user 106 supports that specific team in the match. In such a scenario, the ML model(s) 116 suggest the options related to that specific team, for example, group photos of the whole team. In some embodiments, spatial correlation data associated with the movement of the user 106 is additionally used as a contextual attribute during identity verification of an access request.

In one exemplary embodiment of the present disclosure, the ML model(s) 116 detect whether secondary users (other users) attended the event along with a primary user. The primary user corresponds to the user 106 associated with the user device 104. For such detection, the ML model(s) 116 obtain photos from the media channel(s) 108, such as social media (Facebook, Instagram, or X, formerly known as Twitter). The ML model(s) 116 recognize the presence of other users in the event using the photos obtained from the media channel(s) 108. The other users may be relatives, family members, and/or friends of the user 106 associated with the user device 104. In some aspect, the ML model(s) 116 may access tickets bought by the user 106 from the event promoter server(s) 112. Based on the tickets purchased by the user 106, the ML model(s) 116 may determine a number of users present in the event along with the user 106. Post detection, the content processing system 102 suggests the options to the user 106 according to the presence of other users in the event along with user 106. For example, the content processing system 102 may suggest the options including group photos of the user 106 with the secondary users.

In one exemplary embodiment of the present disclosure, the content processing system 102 creates a digital twin of the user 106 associated with the user device 104. To create the digital twin, the content processing system 102 acquires data related to user 106 and executes the ML model(s) 116 on data to obtain a virtual model designed to accurately reflect the user 106. The ML model(s) 116 are trained and fine-tuned for developing the digital twin of a physical object based on details of the physical object. Further, the content processing system 102 integrates the content related to the user 106 with the digital twin to enhance the experience of attending the event. In some embodiments, the digital twin is stored in association with the verified identity of the user 106 within the cloud-based content repository and is accessible through the admission credential.

In one exemplary embodiment of the present disclosure, the content processing system 102 receives text input from the user 106. For example, the user 106 may want to capture occasions along with a caption. In some aspect, the content processing system 102 may utilize the ML model(s) 116 to detect a particular occasion related to the user 106 based on data received from the media channel(s) 108. The content processing system 102 integrates the text input, the caption, and the photos related to the particular occasion with the frame. The integrated content may form part of the set of content representations stored in the cloud-based content repository and retrievable upon successful authorization.

In one exemplary embodiment of the present disclosure, the content processing system 102 may include the photos associated with the IP right holders, such as logos and photos of players. To include those photos, the user 106 must pay royalties to the IP rights holders. In such case, the content processing system 102 may calculate total cost of the article including those photos, and dynamically update the price associated with the article. Access to licensed content representations may be conditionally enabled based on verification of payment status and satisfaction of licensing policies.

In one exemplary embodiment of the present disclosure, at the event, there are artifacts from the performance that can be included in the frame, for example, smashed guitar bits or game-used balls. Additionally, merchandise sold in the shops can be integrated, for example, concert shirts and team jerseys. These can be optionally added in a collage with a certificate of authenticity from the team/promoter. The certificate of authenticity can be interchangeably termed as proof of validation. Moreover, upgrade options might be possible to have the artifact autographed. Numbered prints of the concert/tour poster could be offered, or even the original art. The home run ball could be offered. Pedigree with tracking and authentication could be guaranteed by the sports club. Proper framing or shadow box to fit the artifacts and the photos are to be chosen. In such a case, the content processing system 102 obtains the details related to the artifacts and generates the options for the user 106 according to the details of the artifacts. In some embodiments, digital records of the artifacts, certificates of authenticity, and associated metadata are stored within the cloud-based content repository and cryptographically associated with the admission credential to ensure traceable and secure ownership verification.

In one exemplary embodiment of the present disclosure, the content processing system 102 obtains the photos from professional photographers if present at the event and includes these photos in the options generated for the user 106 to better memorialize the event. These photos can be provided with a frame, branding, logos, matting, etc. In some embodiments, the professional photographs are securely stored in the cloud-based content repository and made accessible to the user 106 upon successful identity verification and authorization.

The user 106 may provide the user input for selecting one or multiple options through the interface. The user input may be processed by the content processing system 102 to determine a layout according to the items and arrangement provided by the user 106. Further, the content processing system 102 generates a frame for the user 106 based on the layout. The generated frame may include a content access pattern or identifier associated with the admission credential to enable subsequent secure retrieval of related digital assets.

The ML model(s) 116 use machine learning algorithms to analyze and understand the user input to determine the user intent. The ML model(s) 116 transmit the result of the determination to the content processing system 102. The determined user intent may further be evaluated in conjunction with access policies enforced by the identifier manager 118 prior to final content generation.

In one exemplary embodiment, the ML model(s) 116 are designed for content recommendation applications, aimed at enhancing user experience and content generation process. The present disclosure provides a detailed framework describing the input types, processing techniques, and output formats, enabling personalized content generation for the user 106. Various embodiments could integrate with ticketing platforms, performer/team sites, fan sites, venue portals, merchandise vendors, etc., along with any apps that might be on the phone with data to share on the same. The ML model(s) 116 leverage advanced machine learning algorithms to transform input data, ensuring efficient and accurate personalized content recommendation and generation while considering various constraints and preferences.

Moreover, the ML model(s) 116 provide a significant advancement in the field of content processing systems, yielding improved efficiency, customer satisfaction, and revenue generation for businesses. In some embodiments, such advancement further includes secure identity-based access control and cryptographic association of generated content with verified users.

In one exemplary embodiment of the present disclosure, the ML model(s) 116 for content recommendation applications accept a variety of input types, including user preferences, dates of attending the event, number of people attended, along with the user, team supported by the user, historical purchases, and real-time availability status. Additionally, contextual factors, such as weather conditions, holidays, and some events can also be integrated as inputs for a more personalized content suggesting process. In some embodiments, contextual attributes associated with an access indicator are additionally used as inputs for identity validation and secure content delivery.

In one exemplary embodiment of the present disclosure, various ML model(s) 116 could be implemented to enable the content recommendation process as described herein. The ML model(s) 116 include, but not limited to, Recommender Systems, Decision Trees and Random Forests, Neural Networks, Support Vector Machines (SVM), extreme Gradient Boosting (XGBoost), and Gradient Boosting Machines.

Moreover, in some aspects of the present disclosure, upon receiving the input data, the ML model(s) 116 employ data transformation techniques. These include data normalization, feature engineering, and categorical variable encoding to prepare the input data for analysis. The ML model(s) 116 utilize algorithms to discern patterns within the input data, permitting intelligent decision-making. Furthermore, natural language processing techniques can be incorporated to understand user queries conversationally, enabling a more user-friendly experience.

In one exemplary embodiment, the content processing system 102 may comprise recommender systems, such as collaborative filtering and content-based filtering, can be employed to suggest relevant options based on the user preferences and the historical purchase data. The suggested options are conditionally rendered to the user device 104 upon satisfaction with predefined access conditions.

In some aspects of the present disclosure, decision tree-based models like Random Forests are effective in handling complex decision-making processes. They can consider multiple factors simultaneously, making them ideal for optimizing content recommendations based on various constraints.

In one exemplary embodiment of the present disclosure, deep learning models, particularly neural networks, can analyze vast amounts of data and learn intricate patterns. Further, Recurrent Neural Networks (RNNs) can be utilized for processing sequential data, such as historical booking trends, to forecast future demands accurately. In some embodiments, such models may additionally support biometric recognition and similarity score generation for identity verification.

In one exemplary embodiment of the present disclosure, support vector machine (SVM) models are proficient in handling both classification and regression tasks. In the context of ticket booking applications, the SVM can aid in classifying users into different segments based on their preferences, permitting targeted content recommendations.

In one exemplary embodiment of the present disclosure, the XGBoost and Gradient Boosting Machines are ensemble learning techniques that can optimize the ML model's performance by combining the strengths of multiple weak learners. They are particularly useful in scenarios where high accuracy is essential, such as predicting content demand, personalization outcomes, or access validation confidence levels.

In one exemplary embodiment of the present disclosure, the ML model(s) 116 encompass various input types, including the user preferences, the event details, the historical data, the real-time availability, and the contextual factors. The ML model(s) 116 employ data processing techniques, such as data normalization, feature engineering, and natural language processing. It utilizes machine learning algorithms and techniques to analyze the transformed data, ensuring seamless content recommendations and enhanced user experience. In some embodiments, the ML model(s) 116 operate in conjunction with cryptographic modules to securely bind recommended content to verified user identities.

Moreover, the present disclosure employs recommender systems, including collaborative filtering and content-based filtering, for suggesting relevant event-related content options based on the user preferences. Decision tree-based models, such as Random Forests, handle complex decision-making processes, considering multiple factors to optimize content personalization and presentation. Neural networks, particularly RNNs, analyze sequential data like booking trends for accurate demand forecasting. The SVM model classifies user segments based on preferences, enabling targeted recommendations.

Additionally, ensemble learning techniques, like XGBoost and Gradient Boosting Machines, enhance accuracy, especially during peak seasons. The model outputs personalized content recommendations, including ideal items, user’s photos, and pricing information, presented through user-friendly interfaces. The personalized content recommendations are securely associated with the admission credential and retrievable from the cloud-based content repository. This innovation promises to significantly enhance efficiency, customer satisfaction, and revenue generation in the content-creating industry.

In one exemplary embodiment of the present disclosure, the model is designed to handle diverse input types, ranging from user preferences and event details to real-time availability and contextual factors. Through data processing techniques, including data normalization and natural language processing, the input data is prepared for analysis. Leveraging advanced machine learning algorithms, the model provides tailored solutions to the users. The tailored solutions may include the generation of identity-bound digital assets accessible through a content access pattern or admission credential.

In some embodiments, the identified users are further associated with a content access pattern generated by the identifier manager 118. The content access pattern may include an identifier. The content access pattern enables digital linkage between the article and the digital assets related to the event. The digital assets comprise at least one of images captured during an event of the content source, videos captured during the content source, professional photographs, and user-specific digital assets related to the content source.

In one exemplary embodiment, the article includes the content access pattern printed on a mat portion of the frame. The content access pattern provides access to the digital assets stored in a content repository (not shown here) associated with the cloud-hosted platform 120. The content repository includes both media captured and uploaded by a subscribed profile or the user 106 and media provided by the event promoter server(s) 112. In some embodiments, the article includes a digital asset and/or a physical asset. In one example, the article includes a digital photograph or a photo frame hanging on a wall. The content access pattern is associated with the subscribed profile and with the content repository. In another example, the article includes merchandise or artifacts. In some embodiments, the content access pattern comprises a machine-readable identifier that, when scanned, generates the access indicator and enables retrieval of the content representations upon successful identity verification and authorization.

In one exemplary embodiment of the present disclosure, the identifier manager 118 generates, assigns, and manages the content access pattern associated with the articles. The content access pattern comprises at least one of a barcode, a biometric identifier, voice recognition identifier, or a facial recognition identifier, such that access to the cloud-hosted platform 120 is enabled by scanning the barcode or by authenticating the subscribed profile using biometric or facial recognition. In some embodiments, the content access pattern further comprises a machine-readable identifier that, when captured by the user device 104, generates an access indicator transmitted to the identifier manager 118 for identity verification. The identifier manager 118 validates the access indicator against stored mapping records and cryptographically associated admission credentials prior to granting access to digital assets. The mapping records correspond to associations between spatial indicators, metadata, and stored content representations that enable indexed retrieval and identity-based access control.

In one exemplary embodiment of the present disclosure, the article is displayed at a current location of the user 106. The identifier manager 118 assigns a rarefied content access pattern to an article and associates the content access pattern with the corresponding content repository maintained by the cloud-hosted platform 120. The identifier manager 118 further maintains mapping records between the content access pattern, a subscribed profile associated with the user device 104. The mapping records further include access permissions. Based on the mapping records, the identifier manager 118 enables controlled retrieval of the digital assets when the content access pattern is detected by the user device 104.

In some embodiments, the content access pattern includes at least one of a barcode, a token, a matrix-based symbol, a linear marking, a patterned graphic, a visual tag, a symbolic arrangement, or a visually detectable pattern configured for optical capture and decoding. In some embodiments, the mapping records further include a cryptographic hash, digital signature, or encrypted token linking the article, the subscribed profile, and the content repository to prevent unauthorized duplication or spoofing of the content access pattern. Access permissions may define tiered access levels, time-based access rights, or subscription-based entitlements.

In one exemplary embodiment of the present disclosure, the cloud-hosted platform 120 comprises one or more storage systems, e.g., cloud storage, and processors that create and maintain the content repository associated with subscribed profiles. Every single content repository stores the digital assets, including user-captured media, professional media, and event-generated media. The cloud-hosted platform 120 dynamically updates the content repository over time based on a subscription status, access rights, and additional events attended by the user corresponding to the subscribed profile. The cloud-hosted platform 120 further enforces authentication and access control prior to permitting retrieval or presentation of the digital assets associated with the content access pattern.

In one exemplary embodiment, the plurality of digital assets comprises at least one of a poster of the content source, a logo related to the content source, branding related to the content source, content source record, and text provided by the subscribed profile. In some embodiments, additional media/assets are stored in the content repository over time based on updates in the event attended by the user. New content repositories are created based on multiple events attended by the user 106 and/or updates from the multiple events. In some embodiments, the cloud-hosted platform 120 further performs multi-factor authentication, biometric verification, device fingerprint validation, and contextual verification (including location and temporal attributes) prior to authorizing retrieval of digital assets. The cloud-hosted platform 120 may additionally log access events and generate audit records for traceability and compliance purposes.

In one exemplary embodiment, continued access to the event-related digital media is provided to the user 106 associated with the subscribed profile. When the article is created, the identifier manager 118 links the content access pattern on the article to the content repository, thus the identifier represents a digital link between the article and the content repository. The content repository is a digital storage space assigned to the user 106. The content repository stores photos, videos, and other media from the event. The content repository may remain available over time through a subscription. This allows the user 106 to view current and future media related to the event. When the content access pattern on the article is scanned, the user device 104 displays the digital asset stored in the content repository.

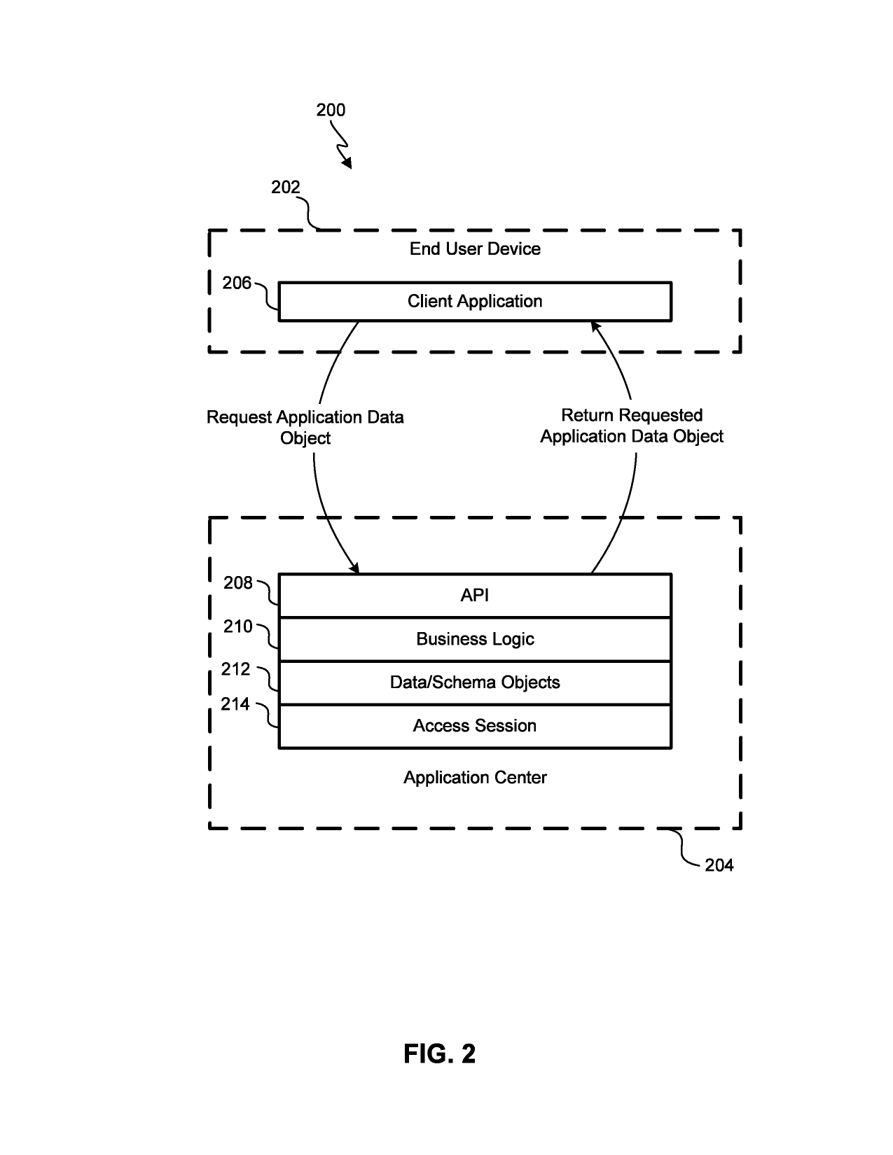

Referring to FIG. 2, a block diagram 200 of user devices and an application interface for interacting with an end user device 202 is shown. Implementation could be done with a progressive web application to support different operating systems and platforms. In one embodiment, the block diagram 200 includes the end user device 202 and an application center 204, which are communicatively coupled with one another. In some embodiments, the end user device 202 includes a client application 206 such that the client application 206 requests application data objects from the application center 204. Further, the application center 204 includes an Application Programming Interface (API) 208, business logic 210, data/schema objects 212, and an access session 214 for performing various operations on data before transmitting data back to the client application 206. In some embodiments, the API 208 receives an access indicator generated in response to detection of a content access pattern and to forward the access indicator to an authentication module for validation prior to execution of the business logic 210.

In some embodiments, the client application 206 is downloaded from the application center 204 and then installed on the end user device 202. The client application 206, upon execution on the end user device 202, provides various features and options for selecting content related to the event and for accessing the digital assets, which are described in more detail with reference to the subsequent drawings. For example, the client application 206 could be a standalone application or added as a plug-in or the like to a ticketing app, team/performer app, venue/event app, etc.

In other embodiments, in place of a dedicated application interface, the content processing system 102 may provide the event-related (personalized or individualized) contents to the user 106 through a web page hosted by a web server. In some embodiments, the client application 206 includes a scanning module configured to capture a machine-readable content access pattern from an article and generate an access indicator. The access indicator may comprise a token, encrypted payload, device identifier, or cryptographic nonce transmitted to the application center 204 for authentication and authorization.

In some embodiments, the access session 214 manages interaction between the client application 206 and the application center 204. The access session 214 may establish, maintain, and terminate a session associated with a user interaction, including verification of access rights, tracking of user activity, and association of requests with a corresponding user account/subscription profile. The access session 214 may further enable controlled access to the digital assets, subscription-based content, and digital assets linked through the content access pattern. In some embodiments, the access session 214 supports secure retrieval of content by validating session credentials before allowing transmission of data to the client application 206. In some embodiments, the access session 214 is established merely after validation of the access indicator against stored mapping records and associated admission credentials. The access session 214 may implement multi-factor authentication, device fingerprint validation, time-based token expiration, and encrypted communication channels to prevent replay attacks, unauthorized access, or session hijacking. The access session 214 may further generate audit logs associated with retrieval of digital assets from the cloud-hosted platform 120.

It must be understood that, in some implementations, the application interface may be provided by the content processing system 102. In other implementations, a third-party server may provide the application interface. In such an implementation, the content processing system 102 may provide personalized content to the user device 104 through the third-party server. In some embodiments, when a third-party server provides the application interface, secure communication channels and authenticated API integrations are established between the third-party server and the content processing system 102 to ensure that access indicators, admission credentials, and digital asset retrieval requests are validated prior to content delivery.

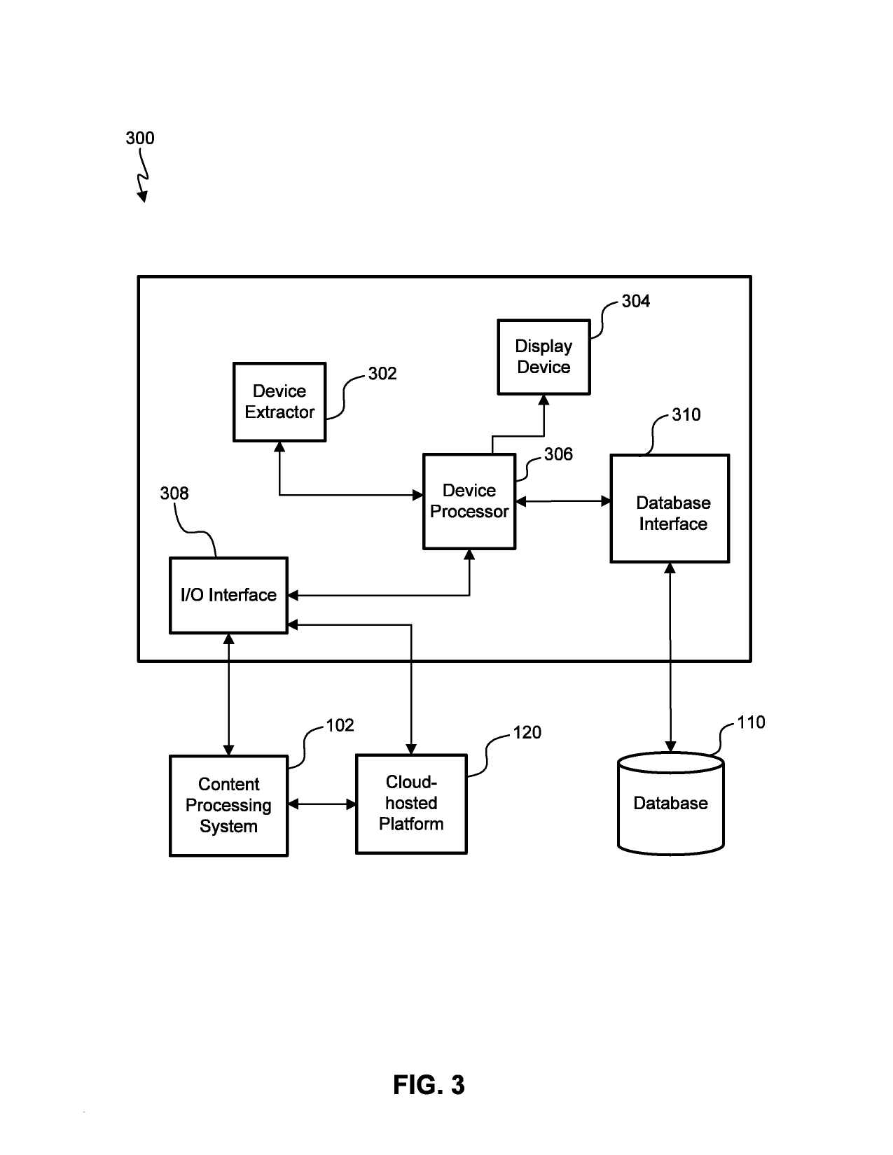

Referring to FIG. 3, a block diagram 300 of the user device 104 according to an embodiment of the present disclosure is shown. The user device 104 comprises components like a device extractor 302, a display device 304 (also referred to as a display, an interface module, or an input processor), a device processor 306, an Input/Output (I/O) interface 308, and a database interface 310. In one embodiment, the user device 104 is communicatively coupled with the content processing system 102, and the cloud-hosted platform 120 via the I/O interface 308. In some embodiments, the user device 104 further includes a scanning module configured to capture a machine-readable content access pattern from an article and generate an access indicator.

The device processor 306 is communicatively coupled to every single other component, like the device extractor 302, the display device 304, the I/O interface 308, and the database interface 310. Further, the device processor 306 communicates with the cloud-hosted platform 120 via the I/O interface 308. Additionally, the device extractor 302 is coupled with the database interface 310 to receive information from the database 110. In some embodiments, the device processor 306 generates, encrypts, or digitally signs the access indicator prior to transmission via the I/O interface 308.

The device extractor 302 extracts the user data from the database 110. Further, the device extractor 302 transmits the extracted user data to the device processor 306. In some embodiments, the extracted user data is used for accessing the digital assets associated with the user 106 from the cloud-hosted platform 120. In some embodiments, the extracted user data includes locally stored admission credentials, device identifiers, biometric authentication data, or subscription tokens used to support identity verification during retrieval of digital assets. In an embodiment, the device extractor 302 receives a signal from a first device processor to transmit the extracted user data to a second device processor for further processing. In some embodiments, the device extractor 302 operates within a secure execution environment of the user device 104 to prevent unauthorized access to credential data.

The display device 304 displays a user interface on the user device 104. The display device 304 receives a signal from the device processors 306 to update the user interface. Additionally, the display device 304 is controlled by the device processors 306 to determine a degree of visibility of the user interface. In some embodiments, the user interface renders the digital assets retrieved from the cloud-hosted platform 120. In some embodiments, the digital assets are rendered within a protected viewing environment that restricts screenshot capture, file export, screen recording, or unauthorized redistribution.

The device processors 306 controls other components, like the device extractor 302, the display device 304, the I/O interface 308, and the database interface 310. The device processors 306 receive data from other components of the user device 104, process the data, and transmit a control signal to the other components based on the processing. Further, the device processor 306 manages authentication, subscription validation, and access requests associated with the cloud-hosted platform 120. The device processors 306 are enabled by the content processing system 102 based on a signal transmitted from the content processing system 102.

In some embodiments, the device processor 306 generates the access indicator in response to detecting the content access pattern, transmits the access indicator to the content processing system 102, receives an authorization response, and conditionally enables rendering of the retrieved digital assets. The device processor 306 may further enforce token expiration rules, session timeout policies, and device-level authentication checks.

The I/O interface 308 functions as an application programming interface (API) to exchange communications between the user device 104 and the content processing system 102. Additionally, the I/O interface 308 enables secure communication between the user device 104 and the cloud-hosted platform 120 for retrieving event-related digital media. Further, the database interface 310 functions as the API to exchange communications between the user device 104 and the database 110. In some embodiments, the I/O interface 308 utilizes encrypted communication protocols and certificate-based authentication to securely transmit the access indicator, receive authorization responses, and retrieve digital assets.

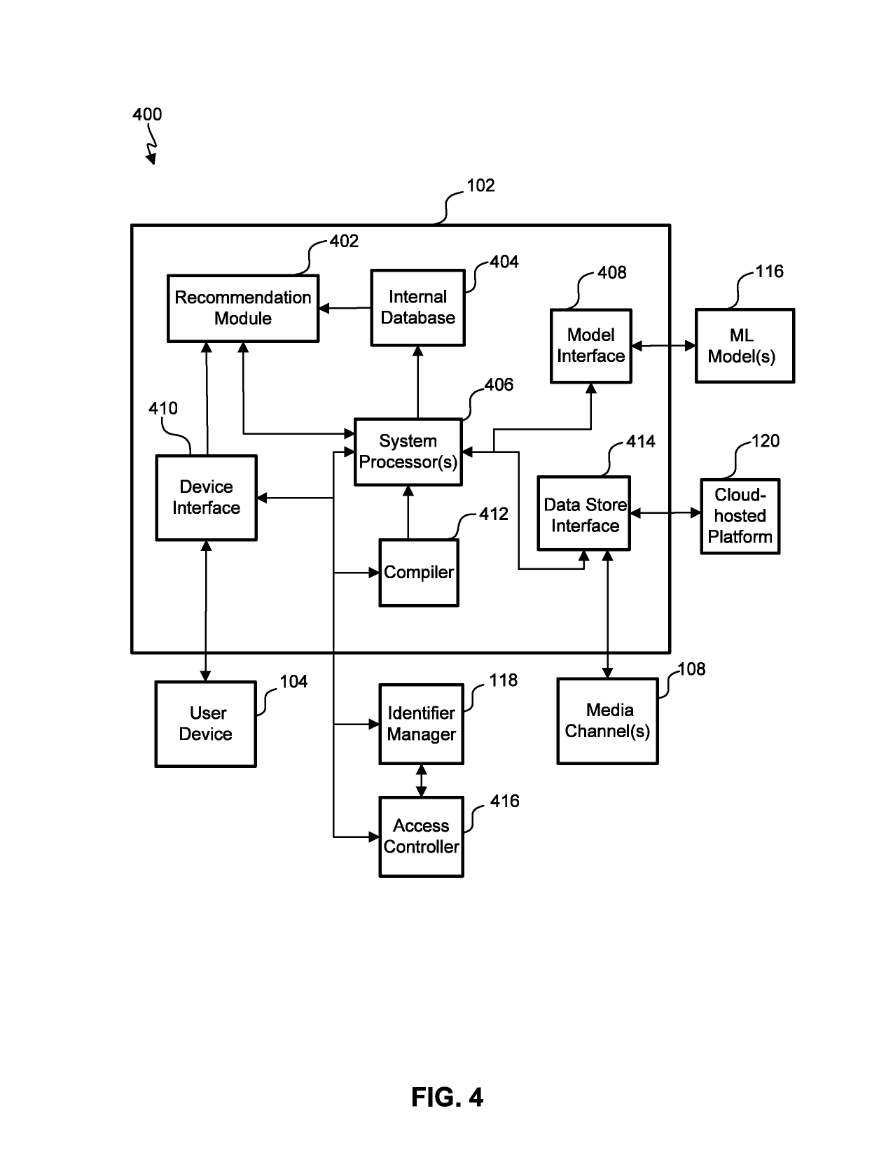

Referring to FIG. 4, a block diagram 400 of the content processing system 102 according to an embodiment of the present disclosure is shown. The content processing system 102 comprises a recommendation module 402, an internal database 404, system processors 406, a model interface 408, a device interface 410, a compiler 412, and a data store interface 414. In some embodiments, the content processing system 102 further comprises an authentication module configured to validate access indicators received from the user device 104 and to coordinate authorization decisions with the identifier manager 118 and the access controller 416.

The content processing system 102 is communicatively coupled with the ML model(s) 116, the media channel(s) 108, the identifier manager 118, the cloud-hosted platform 120, the user device 104, and an access controller 416.

The recommendation module 402 recommends content and/or items for the user 106 associated with the user device 104. The recommendation module 402 is communicatively coupled to the ML model(s) 116 through the model interface 408. The recommendation module 402 generates recommendations based on the user data, the user preferences, and media availability associated with the cloud-hosted platform 120. In some embodiments, the recommendation module 402 generates personalized digital assets and associates every single generated asset with a corresponding content access pattern and subscribed profile identifier.

The internal database 404 stores user credentials at the time of registration/subscription of the user 106 in the system application. The system processors 406 may update the stored user credentials in response to a user request or any unauthorized login that is not initiated by the user 106. In some embodiments, the internal database 404 further stores cryptographic keys, hashed identifiers, encrypted admission credentials, and mapping records linking content access patterns to subscribed profiles and content repositories.

The system processors 406 controls overall function of the content processing system 102. The system processors 406 are communicatively coupled to other components like the recommendation module 402, the internal database 404, the model interface 408, the device interface 410, the compiler 412, and the data store interface 414. Further, the system processors 406 coordinate interactions with the identifier manager 118, the cloud-hosted platform 120, and the access controller 416. In some embodiments, the system processors 406 orchestrate a workflow including receipt of an access indicator, validation of the access indicator, enforcement of access policies, and conditional authorization of digital asset retrieval.

Further, the system processors 406 receive a recommendation result from the recommendation module 402. The recommendation result is analyzed by the system processors 406 to determine the personalized content and available customization options for the user 106. Additionally, the system processors 406 activate the model interface 408 to receive a result from the ML model(s) 116. Further, the system processors 406 activate the device interface 410 to receive the user data from the user device 104. In some embodiments, the system processors 406 further receive the access indicator from the user device 104 and initiate an authentication sequence prior to enabling access to the personalized content.

In addition to that, the system processors 406 activate the device interface 410 to receive the user input or the user data from the user device 104. Components of the content processing system 102, like the model interface 408, the device interface 410, and the data store interface 414 are activated by the system processors 406 by transmission of an activation signal from the system processors 406 to the respective component. Additionally, the system processors 406 receive a result from the compiler 412 to determine the user intent from the user input. The determined user intent is used to generate the customized media/digital asset and to associate the customized media with the corresponding content access pattern. The content access pattern may be visible to the user 106. In some embodiments, the customized media/digital asset is cryptographically bound to the content access pattern and the subscribed profile to prevent unauthorized replication or reassignment.

The model interface 408 retrieves the result from the ML model(s) 116 and transmits it to the system processors 406 based on the activation signal received by the system processors 406. In some embodiments, the model interface 408 may additionally transmit confidence scores or classification outputs used in determining access conditions or personalization tiers.

The device interface 410 receives the user input and the user data from the user device 104 and transmits it to the system processors 406 based on the activation signal received by the system processors 406. In some embodiments, the device interface 410 further receives the access indicator generated in response to detection of the content access pattern and forwards the access indicator to the authentication module for validation.

The compiler 412 receives the user input from the user device 104 via the device interface 410 in a natural language and converts the natural language into a machine level language, which is executable by the system processors 406. In some embodiments, the compiler 412 incorporates natural language processing techniques to extract intent parameters, contextual modifiers, and personalization attributes from user-provided input.

The data store interface 414 retrieves data related to the event and the user from the media channel(s) 108 and transmits it to the system processors 406 based on the activation signal received by the system processors 406. The retrieved data may include event metadata, media assets, and authorization data associated with the cloud-hosted platform 120. In some embodiments, the authorization data includes access policy definitions, subscription entitlements, and rights management metadata associated with intellectual property holders.

In one exemplary embodiment, the identifier manager 118 generates, assigns, and manages content access patterns associated with articles. The identifier manager 118 links every single content access pattern with a corresponding content repository maintained by the cloud-hosted platform 120. In some embodiments, the content repository is generated based on the user location in the event, the event metadata, and media from the media channel(s) 108. The event metadata is associated with performance, artists, stage, specific locations at the event, or time frames with respect to performance.

In some embodiments, the identifier manager 118 receives an initiation request corresponding to a content access pattern, wherein the initiation request is processed for accessing the content repository. The identifier manager 118 authenticates the initiation request using one or more authentication mechanisms. The one or more authentication mechanisms comprise at least one of device-based authentication, biometric authentication, credential verification, facial recognition, authentication using an encoded code, or multi-factor authentication. The identifier manager 118 evaluates the authenticated initiation request against an access policy selected from a plurality of access policies. A controlled access to at least a portion of the content repository is provided based on the evaluation. The plurality of access policies defines one or more access conditions, including at least one of unrestricted access, limited access, time-restricted access, content-specific access, or denied access. In some embodiments, evaluation of the access policy further includes verification of token validity, cryptographic signature validation, device fingerprint comparison, and contextual verification, including temporal and geolocation constraints.

The cloud-hosted platform 120 stores, updates, and manages the content repository associated with every single subscribed profile. Every single content repository stores the digital assets and is accessible upon successful authentication and scanning of the corresponding content access pattern. In some embodiments, retrieval of digital assets is permitted merely upon receipt of an authorization confirmation from the content processing system 102 and the access controller 416.

The access controller 416 authenticates user access requests. The access controller 416 verifies subscription status, credential records, device association, and session validity before granting access to the cloud-hosted platform 120. The access controller 416 manages access control and authentication. In some embodiments, the access controller 416 separates authentication (identity verification) from authorization (policy-based access determination) and generates an authorization token permitting retrieval of digital assets for a defined duration and scope.

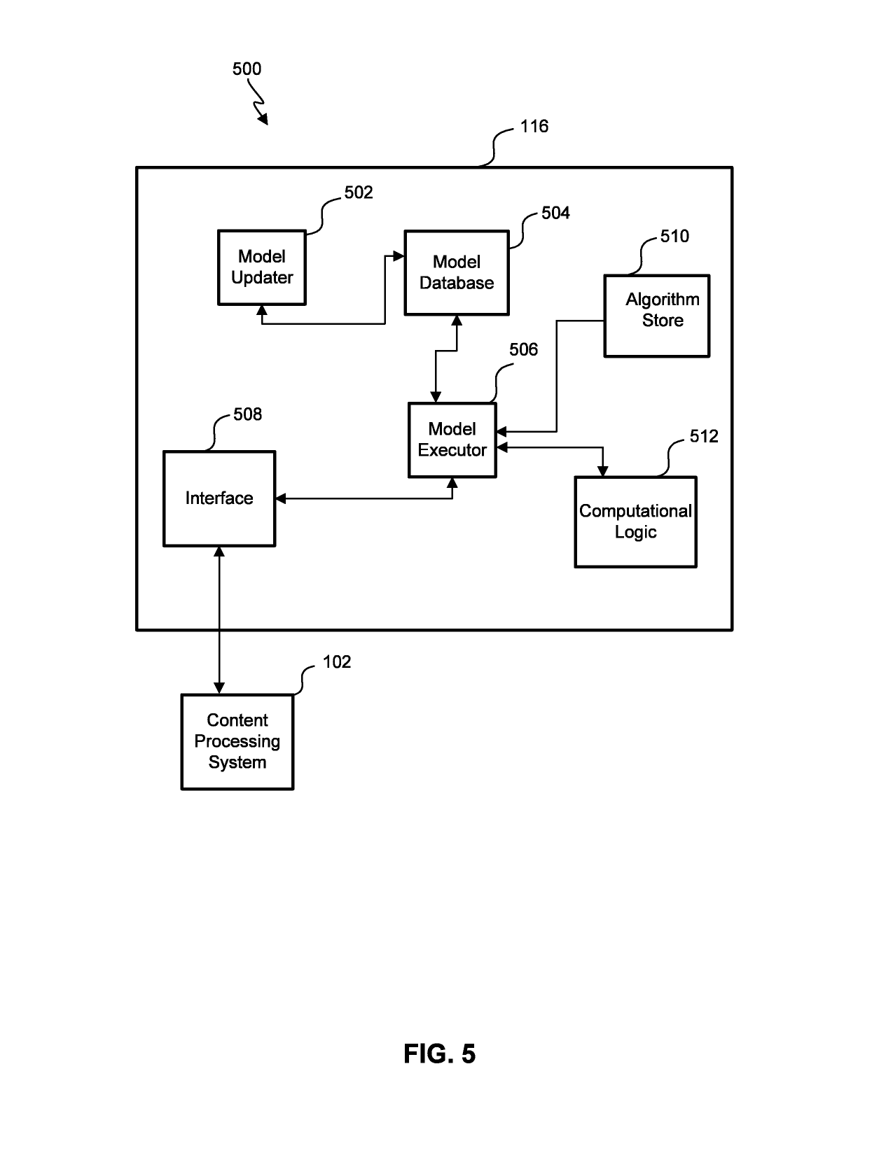

Referring to FIG. 5, a block diagram 500 of an example of the ML model(s) 116 according to an embodiment of the present disclosure is shown. The ML model(s) 116 comprise a model updater 502, a model database 504, a model executor 506, an interface 508, an algorithm store 510, and a computational logic 512.

The model updater 502 updates the ML model(s) 116 based on feedback data associated with the machine learning result received by the content processing system 102. The feedback data indicates accuracy, relevance, and user interaction outcomes related to the generated content. In some embodiments, the feedback data further includes access outcome data, including whether a personalized digital asset was accessed, partially accessed, or denied based on applied access policies.

In one exemplary embodiment of the present disclosure, the ML model(s) 116 use neural networks, such as convolutional neural networks (CNNs), recurrent neural networks (RNNs), and the like, to determine the intent of the user 106 based on the user input. The feedback data indicates the efficiency of a result of the determination of the user intent. In another embodiment, the ML model(s) 116 determine the content to be suggested for the user 106 based on the user intent, user preferences, and user characteristics. In another embodiment, the ML model(s) 116 determine the content for the user 106 based on the user location during the event. Based on the feedback data, the model updater 502 accesses the model database 504 to update neuron weight of the neural network to increase the efficiency of the ML model(s) 116. The updates are applied through the computational logic 512. In some embodiments, the ML model(s) 116 further process contextual verification attributes, including device identifiers, temporal attributes, and event metadata, to generate a personalization output that is subsequently associated with a content access pattern and a subscribed profile.

The model database 504 stores neural networks, weights of neurons for the neural networks, input data for the neural networks, output data from the neural networks, and the like. The model database 504 transmits the stored data to the model updater 502 and receives the updated data from the model updater 502 for storage. Additionally, the model database 504 transmits a neural network from the stored neural networks to the model executor 506 for execution of the neural network.

The model executor 506 executes the neural networks stored in the model database 504 based on instruction data received from the content processing system 102. In an embodiment, the model executor 506 executes the neural network to recommend the content to be provided to the user 106 based on the user intent, the user preferences, and the user characteristics.

For execution of the neural networks, the model executor 506 transmits an indication of a machine learning algorithm to the algorithm store 510. The algorithm store 510 stores multiple machine learning algorithms. Based on the indication, the algorithm store 510 transmits the corresponding machine learning algorithm from the multiple machine learning algorithms. Similarly, the model executor 506 transmits indication of a neural network model for selection of a neural network from the model database 504. In some embodiments, algorithm selection is dynamically performed based on event type, user segmentation category, or subscription tier.

The interface 508 receives the feedback data from the content processing system 102 and transmits the feedback data to the model updater 502. Additionally, the interface 508 receives the instruction data from the content processing system 102 and transmits the instruction data to the model executor 506. The interface 508 further enables communication of intermediate results generated by the computational logic 512.

In an embodiment, the ML model(s) 116 are trained and fine-tuned to recommend the content for a specific user based on several aspects, such as a type of the event, details of team or artist performed in the event, number of attendees related to the user, geolocation/ user location of the user during the event, the user intent, the user preferences, the user characteristics, data obtained from social media channel, and information received from the promotors of the event. For example, if a user attended a football match, the ML model(s) 116 determine details of players playing in the match, a team supported by the user 106, user’s previous purchases, and so on. Such determination may be made based on data obtained from user’s shared database, media channels database, and promotor’s database.

Based on the determination, the ML model(s) 116 predict the content for suggesting options to the user 106. Based on the determination, the computational logic 512 predicts the content and generates output signals for suggesting the options to the user. In some embodiments, the predicted content is packaged with a personalization identifier and transmitted to the content processing system 102, which binds the predicted content to a content access pattern and corresponding content repository. The ML model(s) 116 may further output an access-tier recommendation used by the access controller 416 in enforcing content visibility or entitlement rules.

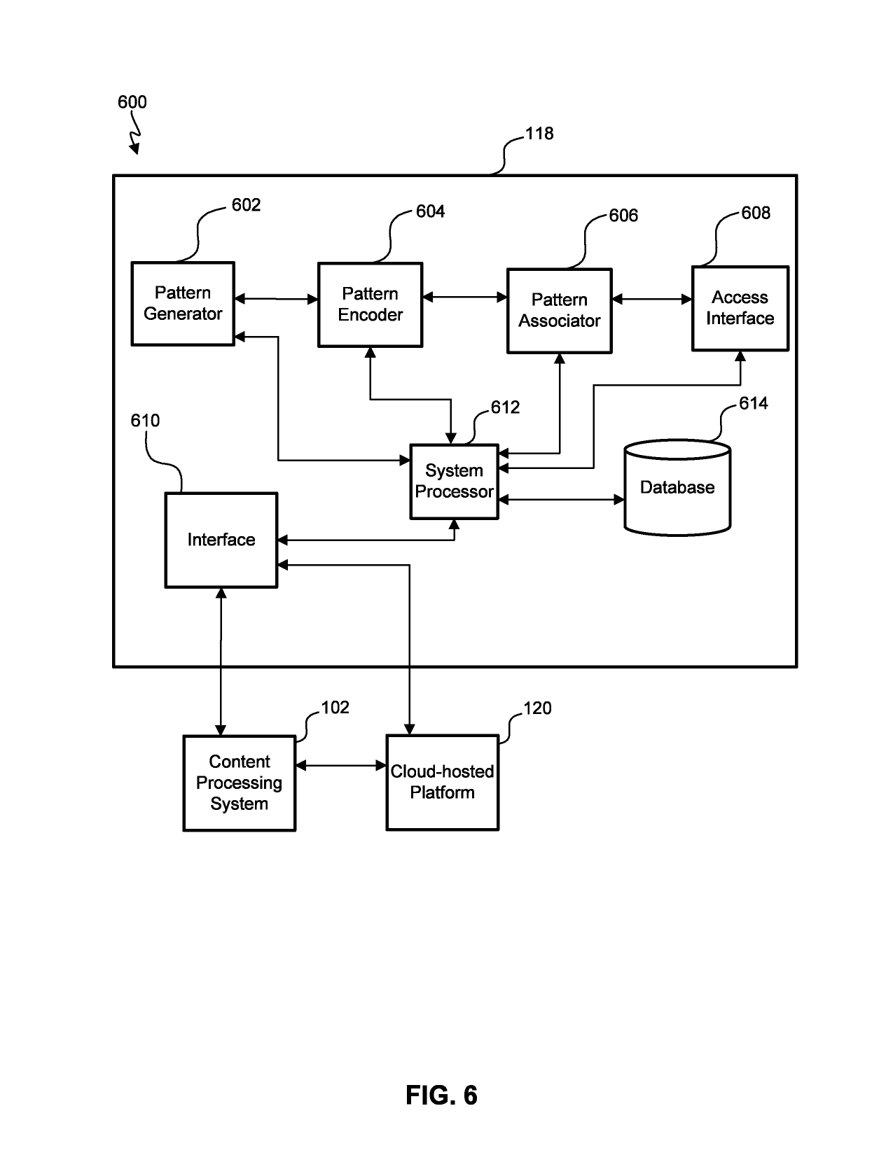

Referring to FIG. 6, a block diagram 600 of the identifier manager 118 according to an embodiment of the present disclosure is shown. The identifier manager 118 comprises a pattern generator 602, a pattern encoder 604, a pattern associator 606, an access interface 608, an interface 610, a system processor 612, and a database 614.

The identifier manager 118 is communicatively coupled with the content processing system 102 via the interface 610. Further, the identifier manager 118 is communicatively coupled with the cloud-hosted platform 120 via the interface 610.

In one exemplary embodiment, the identifier manager 118 generates, encodes, manages, and controls access to the content access pattern that is associated with personalized content. The identifier manager 118 enables secure linking between the article and the corresponding personalized content created for the user 106.

The pattern generator 602 creates the content access pattern for the event. The content access pattern may include at least one of a barcode, a quick response (QR) code, a matrix code, a watermark, a visual symbol, or a machine-readable graphic. The pattern generator 602 generates the content access pattern based on event information, user information, content identifiers, or a combination thereof.

In one exemplary embodiment, the pattern encoder 604 encodes data into the content access pattern generated by the pattern generator 602. The encoded data may include a content identifier, a user identifier, subscription information, authentication data, access rules, or a secure token. The encoding ensures that the content access pattern is readable merely by authorized devices and systems.

In one exemplary embodiment, the pattern associator 606 associates the content access pattern with the corresponding personalized content repository related to the event. The personalized content repository may include images, videos, audio clips, text, certificates, or digital artifacts of the event. The pattern associator 606 links the content access pattern to the personalized content stored in the content processing system 102 or the cloud-hosted platform 120.

In one exemplary embodiment, the access interface 608 manages access to the personalized content repository when the content access pattern is scanned or detected. The access interface 608 verifies subscription status, authentication credentials, and access permissions of the user 106. Based on the verification, the access interface 608 allows, restricts, or customizes access to the personalized content repository containing personalized content.

In one exemplary embodiment, the interface 610 enables communication between the identifier manager 118, the content processing system 102, and the cloud-hosted platform 120. The interface 610 supports data exchange related to pattern generation, content association, user authentication, subscription validation, and content delivery.

In one exemplary embodiment, the system processor 612 controls the overall operation of the identifier manager 118. The system processor 612 executes instructions to generate the content access pattern, encode data, associate the content repository, perform authentication checks, and manage subscription-based access. The system processor 612 may include one or more processing units.

In one exemplary embodiment, the database 614 stores the content access pattern, user profiles/subscription profiles, subscription details, authentication tokens, access logs, and the digital asset. The database 614 enables the retrieval of stored information during scanning or access requests.

In one example, when a user 106 scans the content access pattern using a user device 104, the identifier manager 118 receives an access request through the access interface 608. The system processor 612 authenticates the user 106 and verifies subscription information stored in the database 614. Upon successful verification, the pattern associator 606 retrieves the associated personalized content from the content processing system 102 or the cloud-hosted platform 120 and provides access to the user 106.

Additionally, the identifier manager 118 enables secure, subscription-based, and authenticated access to the personalized event content using the content access pattern, enhances user engagement, and provides an immersive event experience.

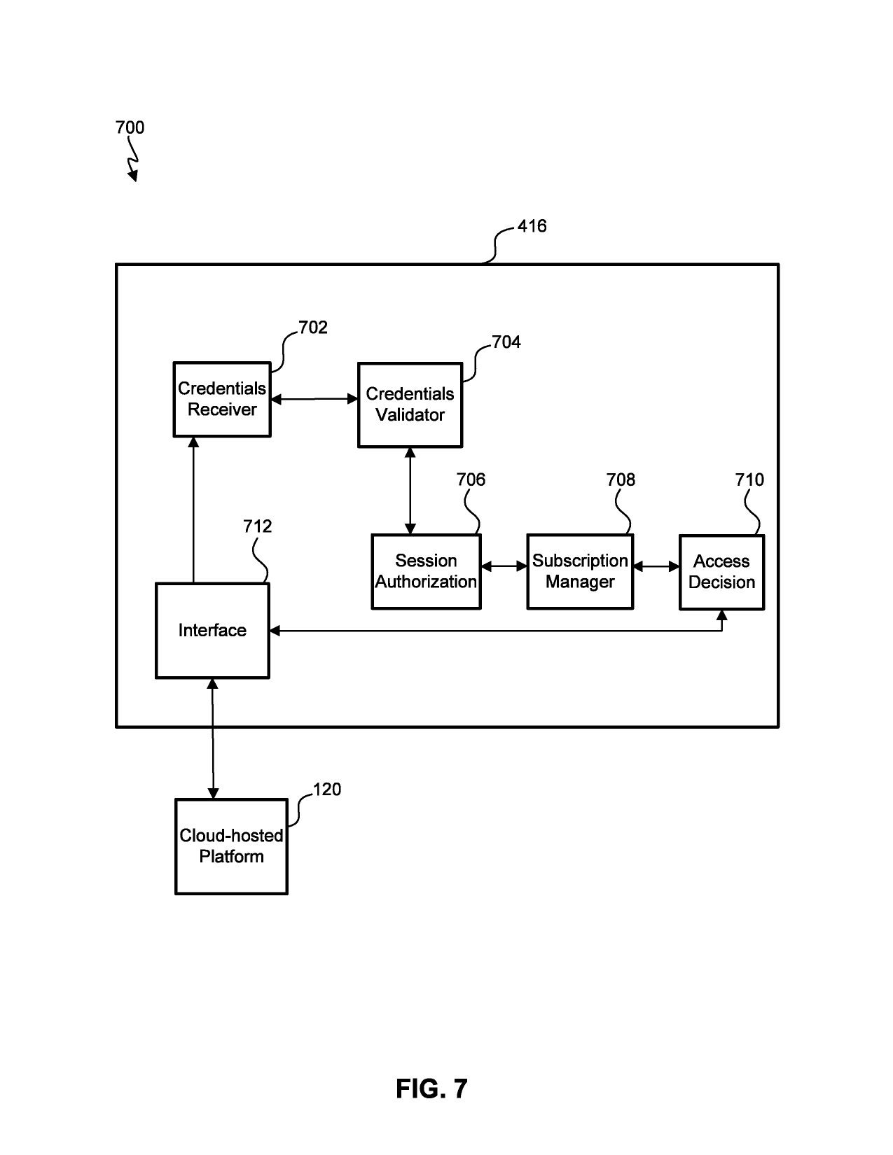

Referring to FIG. 7, a block diagram 700 of the access controller 416 according to an embodiment of the present disclosure is shown. The access controller 416 comprises a credentials receiver 702, a credentials validator 704, a session authorization module 706, a subscription manager 708, an access decision module 710, and an interface 712. In some embodiments, the access controller 416 is communicatively coupled with the cloud-hosted platform 120.

The access controller 416 controls and manages access to the personalized content repository associated with the content access pattern. The access controller 416 ensures that authorized users alone are permitted to access the personalized content based on authentication credentials and subscription status.

The credentials receiver 702 receives access-related information/credentials from the user device 104 when the user 106 attempts to access the personalized content repository. The access-related credentials may include login credentials, authentication tokens, device identifiers, user identifiers, or data extracted from the content access pattern. The login credentials may include a username and a corresponding password.

The credentials validator 704 validates the received access-related credentials. The credentials validator 704 verifies the authenticity of the user 106 by comparing the received credentials with stored credentials, authentication data obtained from the cloud-hosted platform 120, or the user database. The validation may include password verification, token validation, or multi-factor authentication.

The session authorization module 706 establishes an authorized session for the user 106 upon successful validation of the credentials. The session authorization module 706 generates a secure session identifier and maintains session parameters, such as session duration, access scope, and session status, during content access.

The subscription manager 708 determines whether the user 106 has an active subscription or entitlement to access the personalized content repository. The subscription manager 708 retrieves subscription information/ subscription status related to the user 106 from the cloud-hosted platform 120 or a subscription database. The subscription information may define content access level, duration of access, and content usage limits.

The access decision module 710 makes a final determination regarding access to the personalized content repository. The access decision module 710 evaluates the results from the credentials validator 704, the session authorization module 706, and the subscription manager 708. Based on the evaluation, the access decision module 710 allows unrestricted access, partial access, limited access, or deny access to the personalized content.

In an exemplary embodiment, the interface 712 enables communication between the access controller 416, the identifier manager 118, the content processing system 102, and the cloud-hosted platform 120. The interface 712 transmits authentication requests, subscription verification requests, access decisions, and content delivery instructions.

In one exemplary scenario, a content access pattern is printed on an article associated with an event and is linked to the personalized content repository containing one or more personalized digital assets for a user 106. When a device, excluding the user device 104, such as a device belonging to another user, scans the content access pattern, the scan request is transmitted to the access controller 416. The access controller 416 identifies that the requesting device is not registered as the authorized user device for the content repository. Based on the identification, the access controller 416 restricts direct access to the content repository and generates a notification.

The notification is sent to the user device 104 of the user 106, informing the user 106 that another device is attempting to access the content repository associated with the content access pattern. The user 106 may approve or deny the access request through the user device 104. If the user 106 approves the request, the access controller 416 establishes a temporary or limited access session for the requesting device. If the user 106 denies the request or does not respond within a predefined time period, the access controller 416 blocks access to the content repository.

Upon approval, the access controller 416 enables access to the personalized content through the cloud-hosted platform 120. If validation or subscription verification fails, the access controller 416 restricts or denies access and may prompt the user 106 to authenticate, subscribe, or upgrade a subscription. In some embodiments, the access controller 416 provides a secure, controlled, and subscription-aware mechanism for accessing personalized event content while preventing unauthorized access.

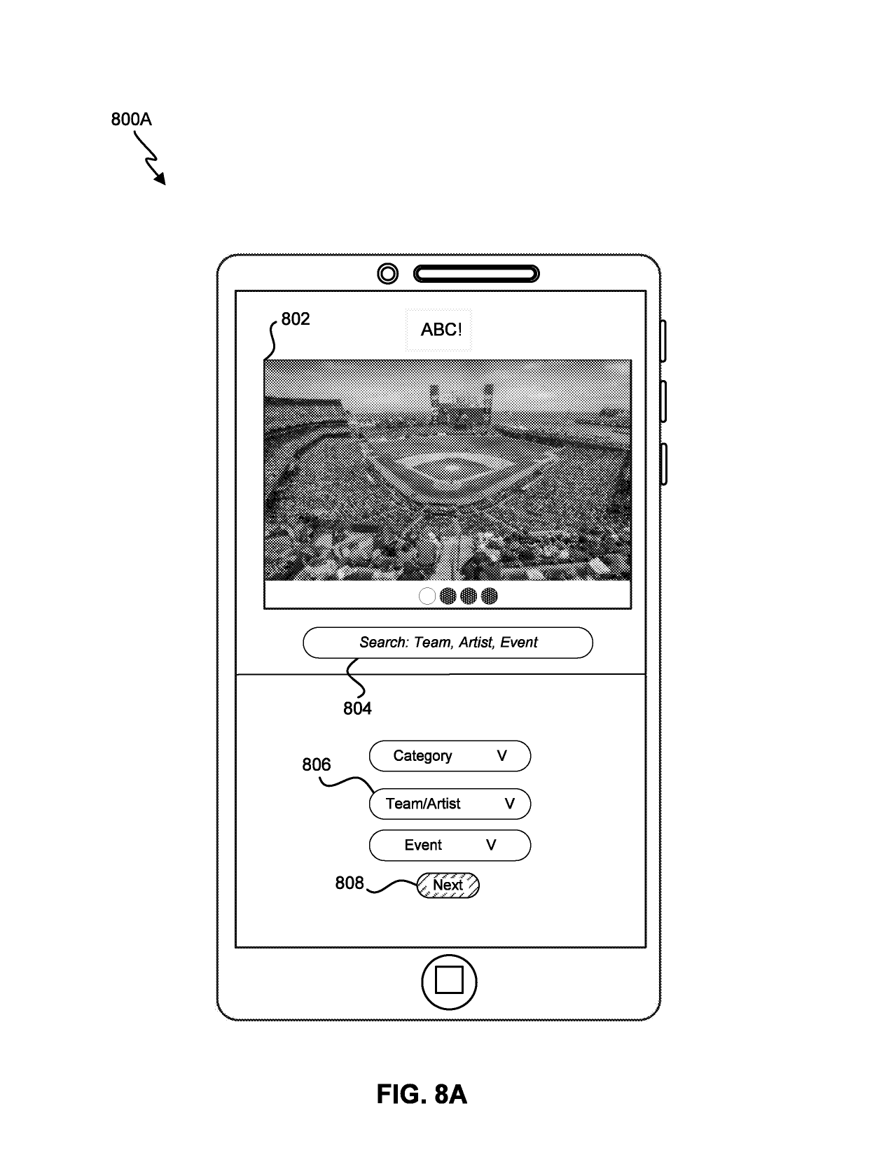

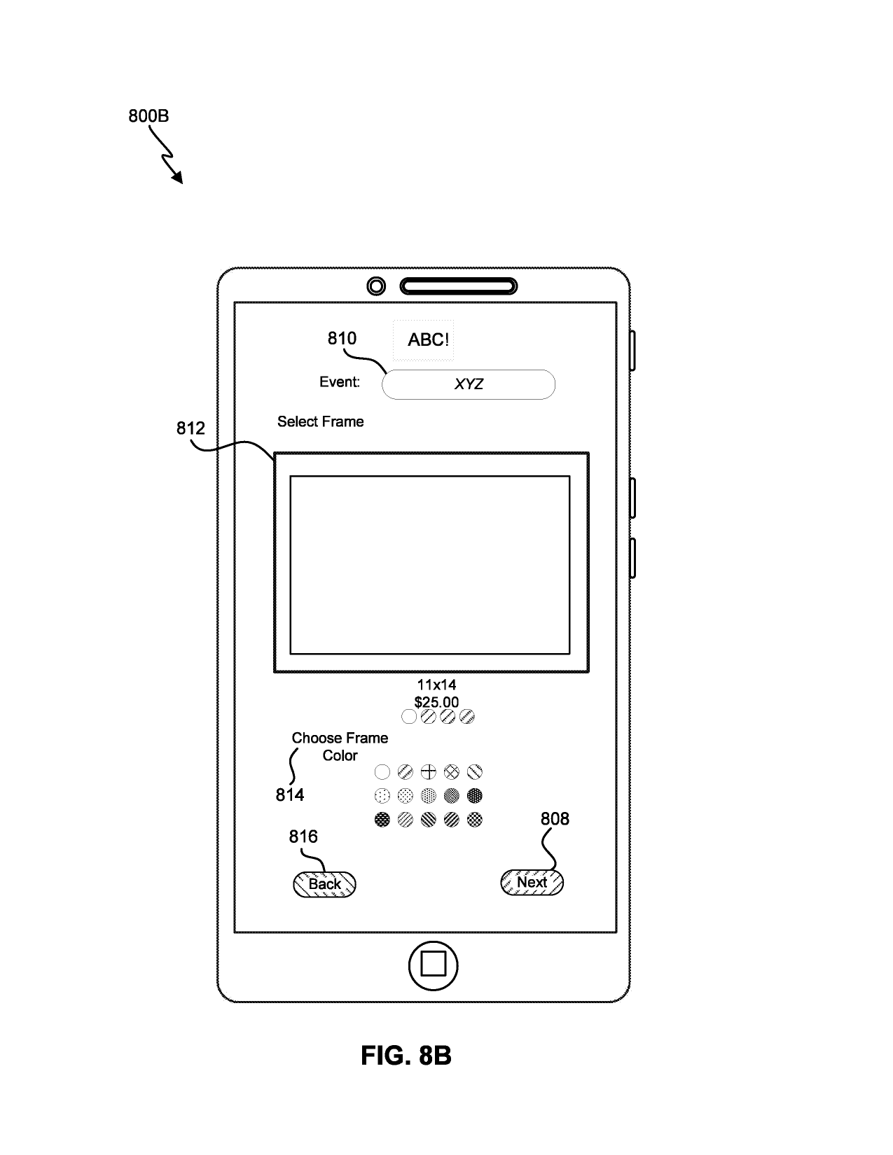

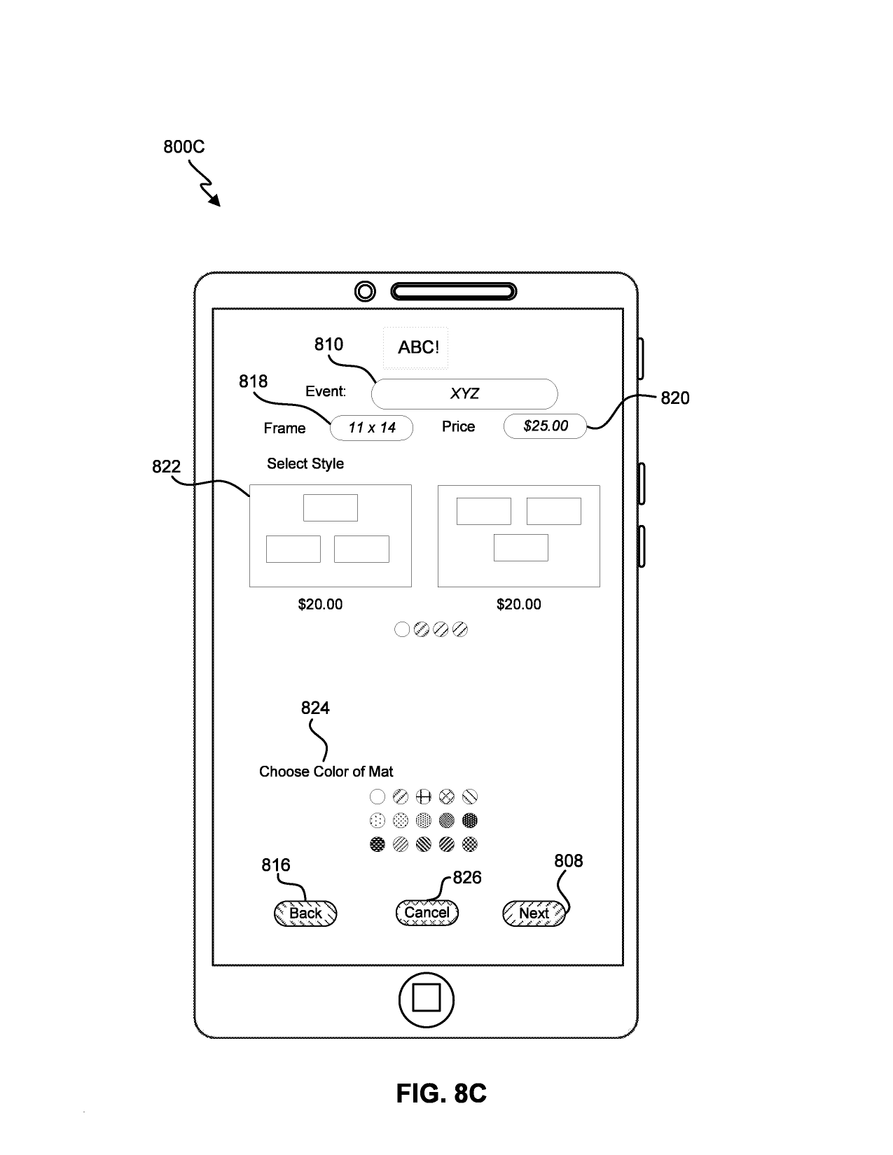

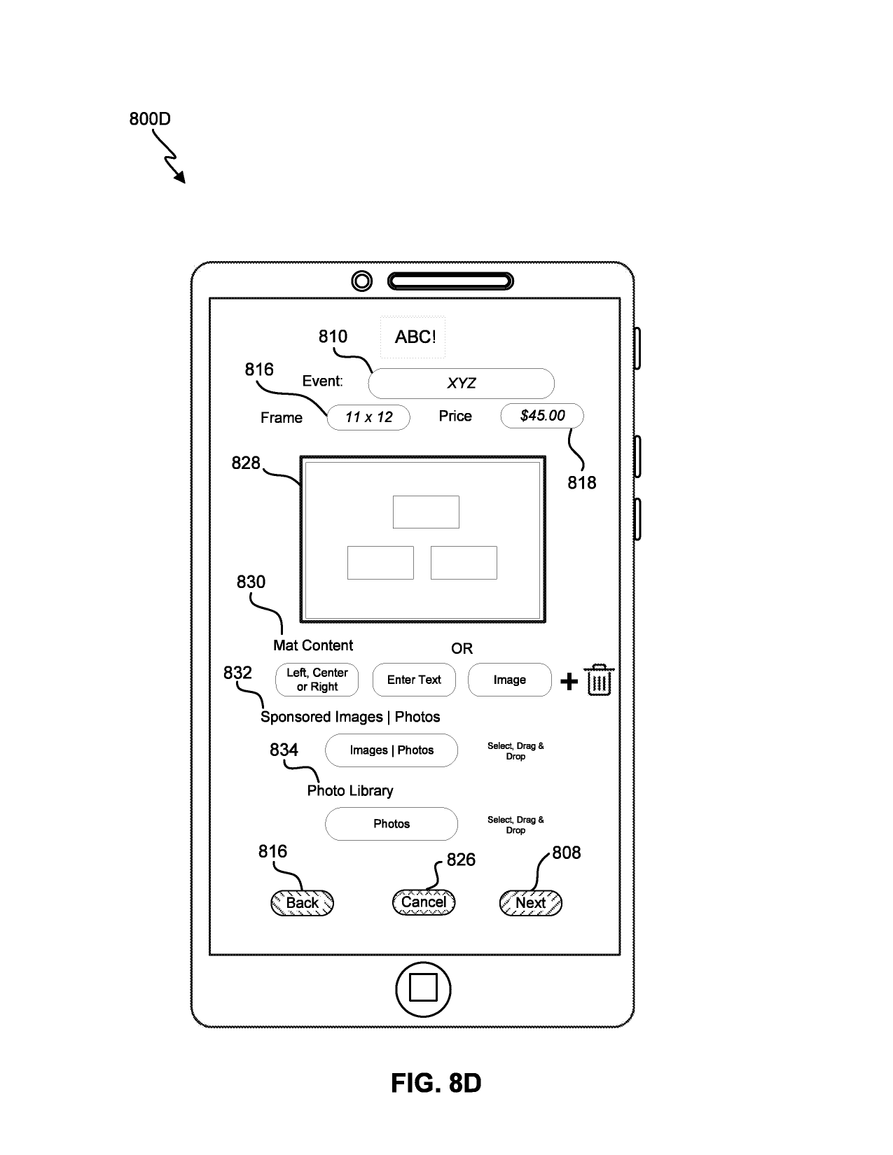

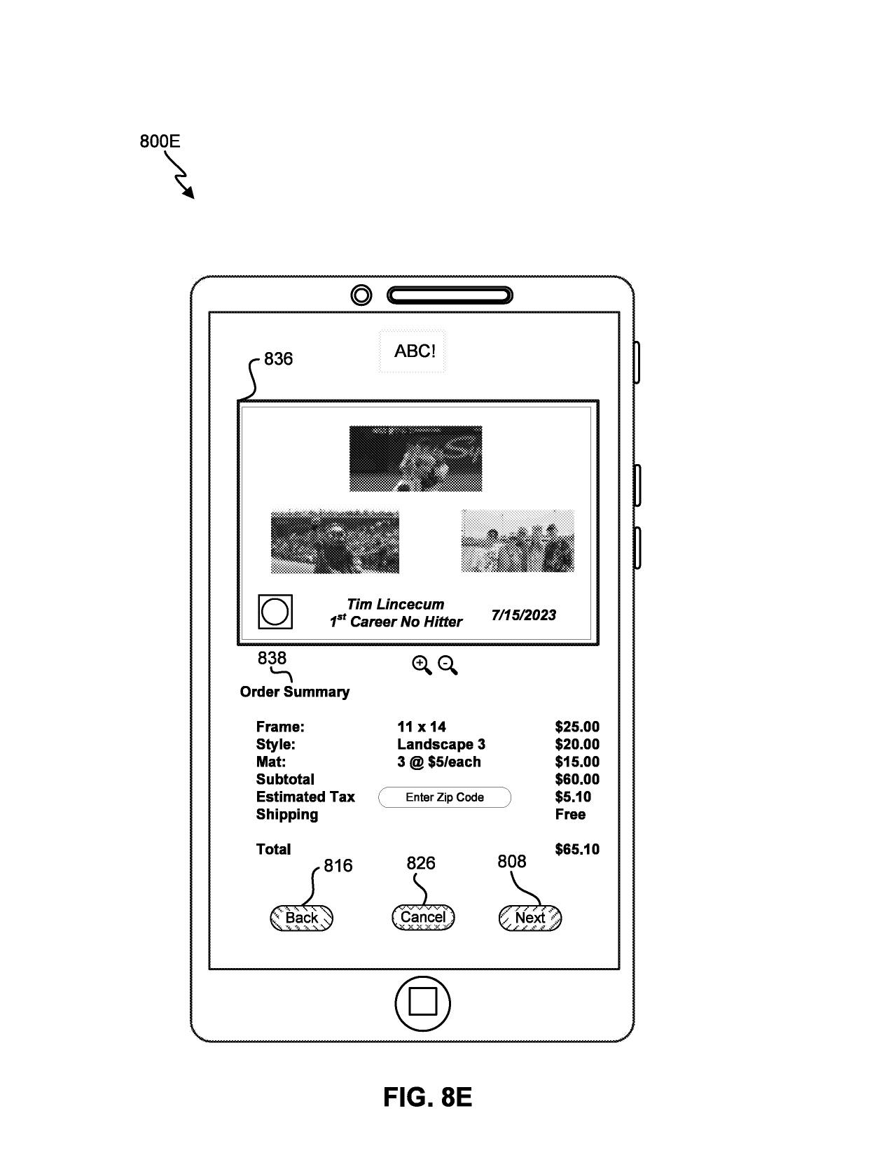

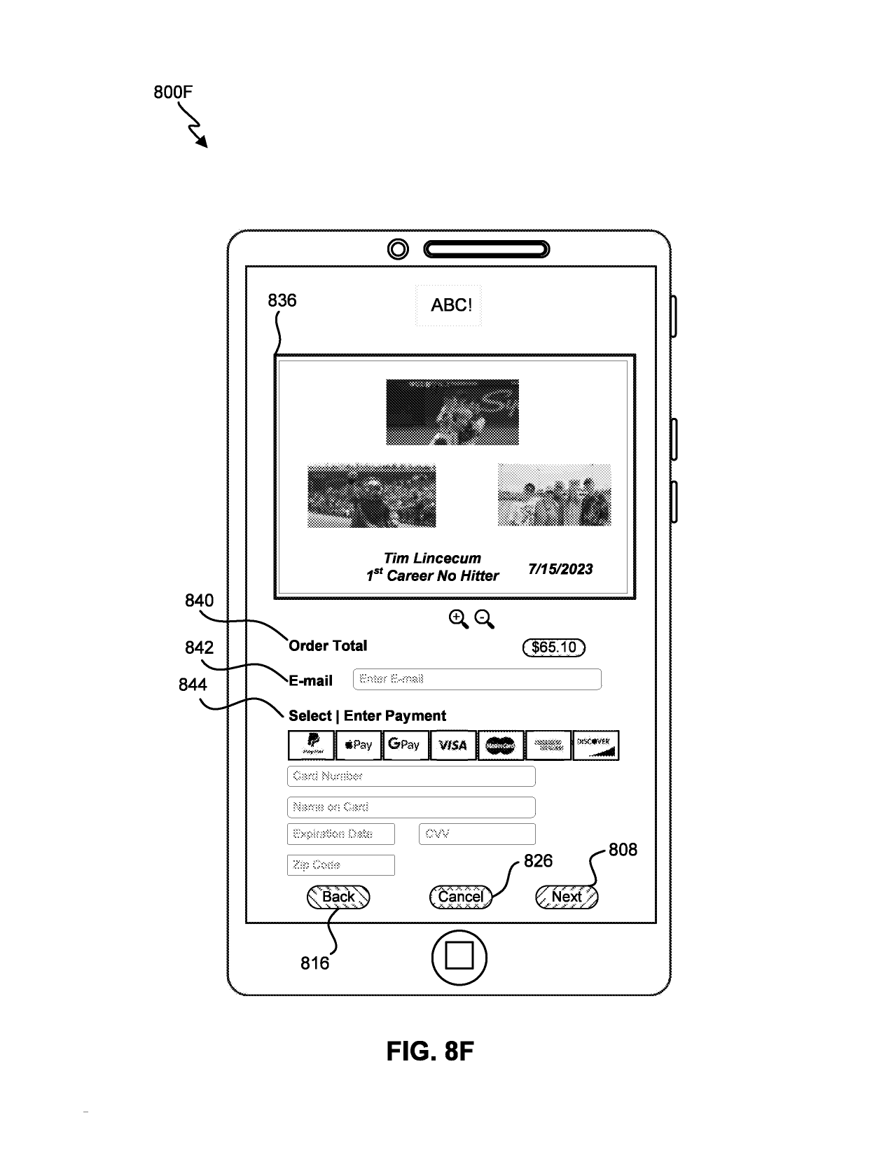

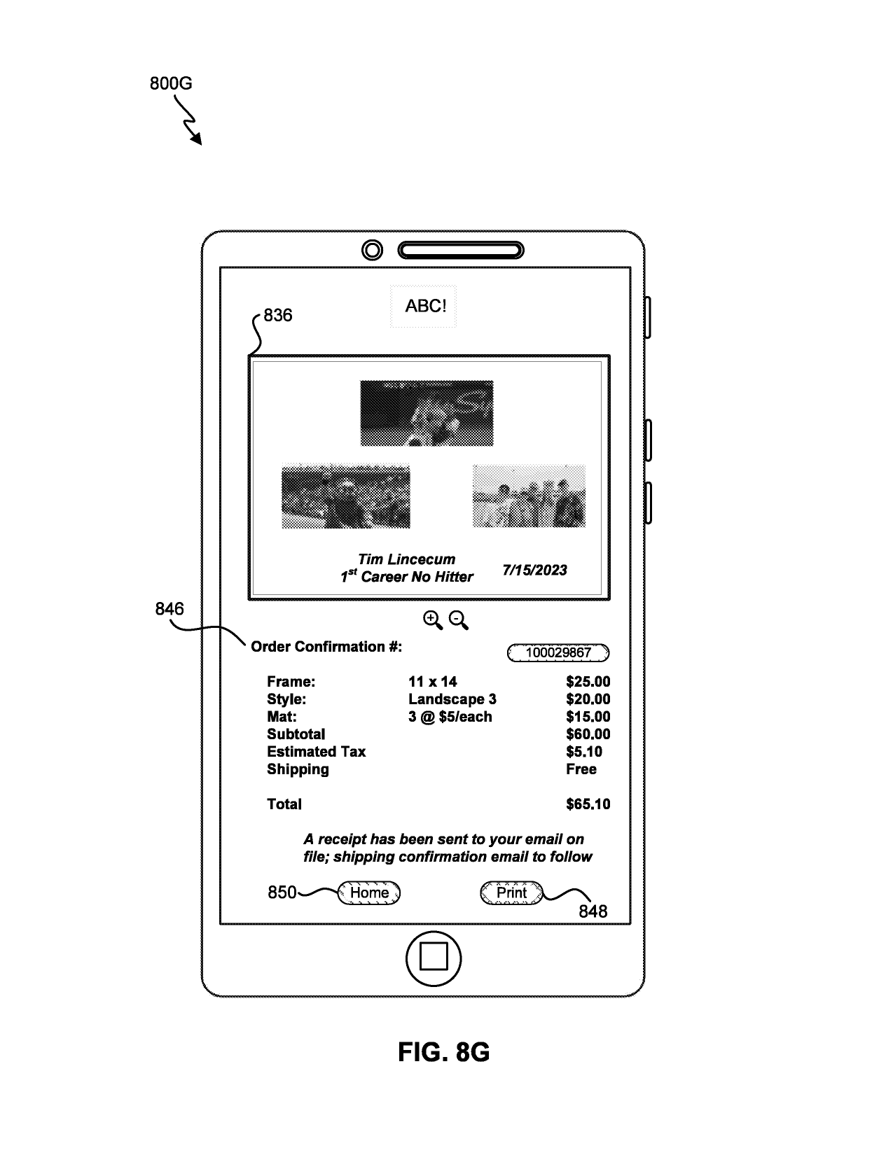

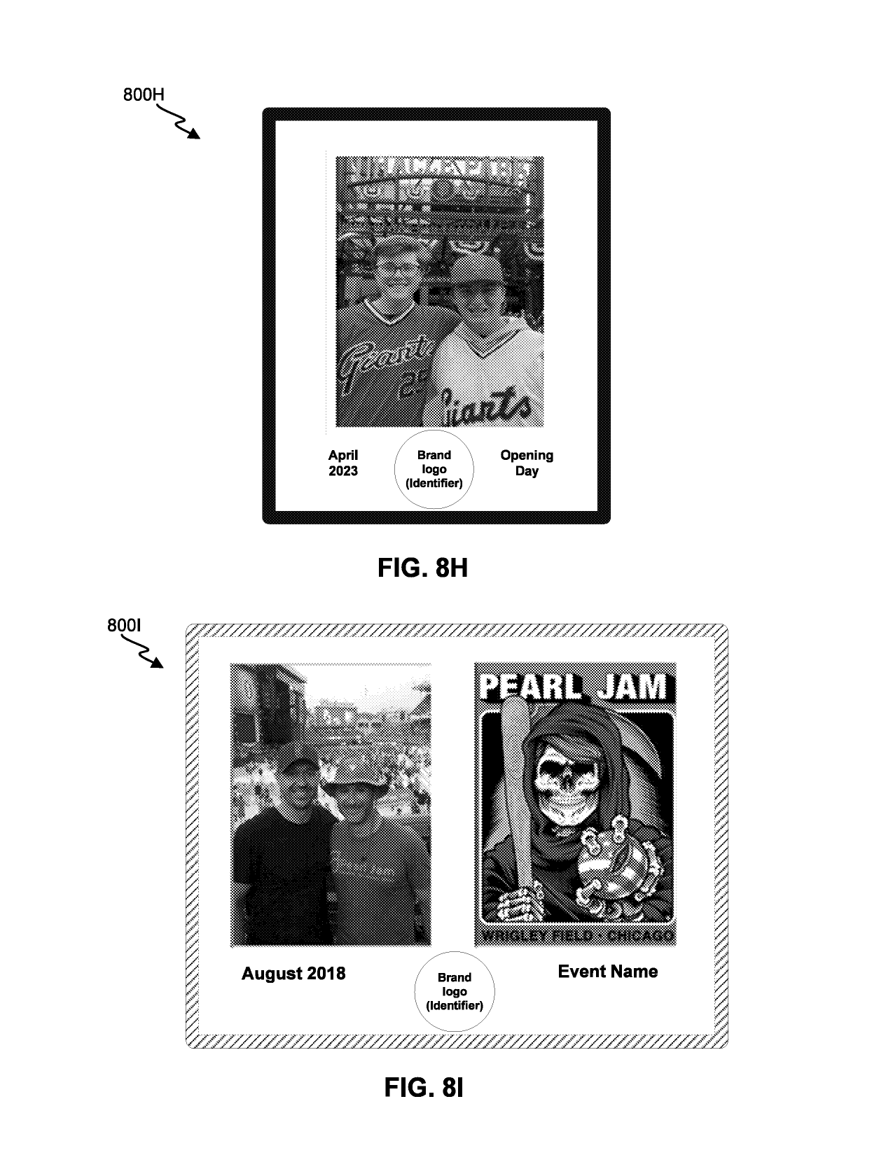

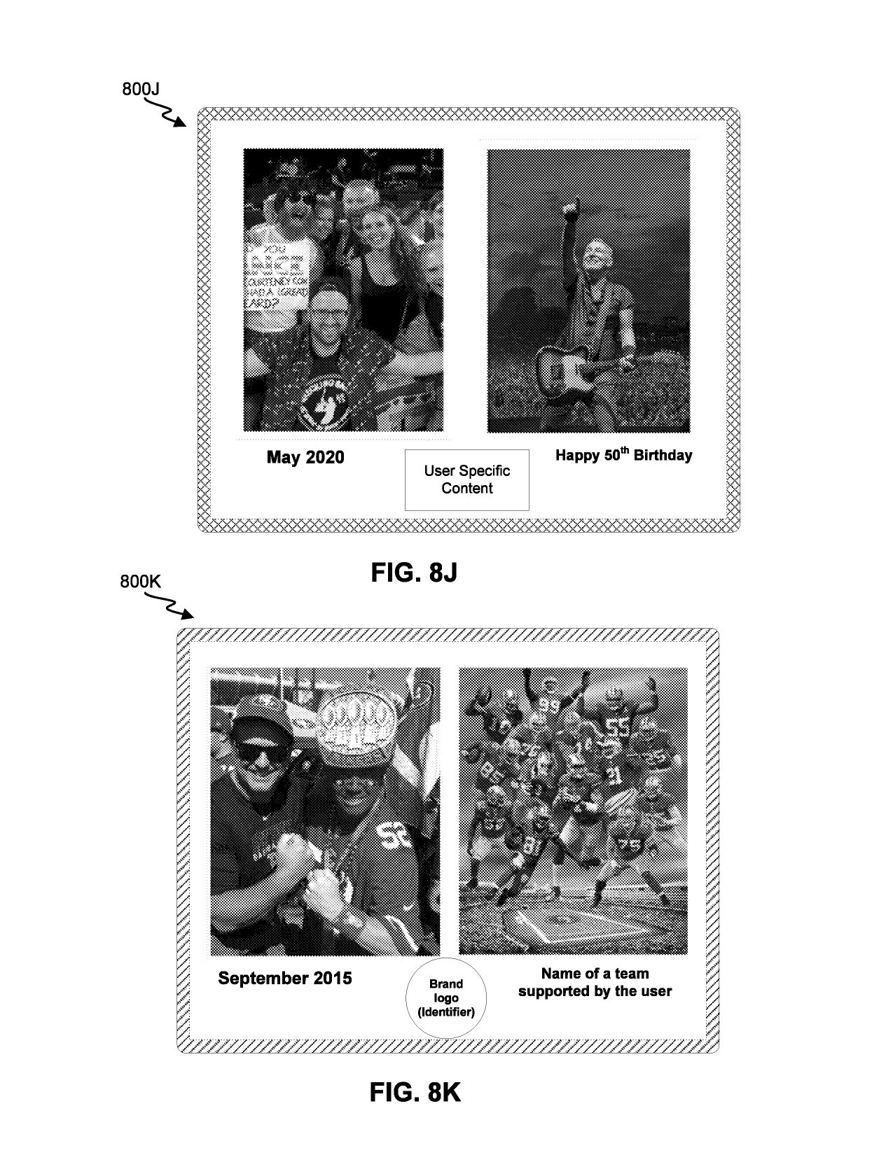

FIG. 8A illustrates an example embodiment of an interface diagram 800A of an application interface generated by the content processing system 102 according to the present disclosure. The application is a progressive web application communicatively coupled with the system application of the content processing system 102.

The application interface may be presented on the display device 304 based on the content recommended by the ML model(s) 116. The user 106 may use the user credentials to log in to the system application. Once the user 106 logs into the system application, the application interface may be presented on the user device 104.

Further, the application interface includes an element 802, an element 804, an element 806, and an element 808. The element 802 indicates the content recommended by the ML model(s) 116. In an example, the content may be a 3D view of the venue of the event, photos accessed from the user device 104, and/or photos acquired from social media.

Element 804 indicates an option to search for a team, an artist, and an event. The user 106 may search for the content related to a specific team or an artist through a search term. In response, the content processing system 102 parses the content and selects the content related to the search term.

Element 806 indicates an option to sort the content based on a category of the event, a team or artist that performed in the event, and the name of the event. In one embodiment, the element 806 may be provided in drop-down format.

The user 106 may select options rendered on the display device 304. For example, the user 106 may select a 3D view of the ground. Upon selecting the option, the user 106 may press the element 808. The element 808 enables the next options rendered on the display device 304.

FIG. 8B illustrates an example embodiment of an interface diagram 800B of the application interface generated by the content processing system 102 according to the present disclosure. The application interface is an interface of the system application associated with the content processing system 102. The application interface may be presented on the display device 304 based on the content recommended by the ML model(s) 116.

Further, the application interface includes an element 810, an element 812, and an element 814. The element 810 indicates a name of the event selected by the user 106. For example, if the user 106 selects an event named “ABC” on the interface diagram 800A as illustrated in FIG. 8A, the interface diagram 800B renders “ABC” as the element 810.

The element 812 indicates options of frames of varied sizes to be selected by the user 106. For example, the element 812 may include frames of varied sizes, such as 11 x 14, 10x 12, and so on. The element 812 may have an option to slide left or right to select a desired size of the frame. In an embodiment, a price associated with a corresponding frame may also be shown on the display device 304.

The element 814 indicates an option to choose a color of the frame. In one embodiment, the element 814 may be provided with multiple color options. The user 106 may tap on the color option desired to put on the frame.

The user 106 may select options rendered on the display device 304. For example, the user 106 may select a 11X14 frame in the element 812 and a brown color in the element 814. After selecting the options, the user 106 may press the element 808 for further processing. Alternatively, the user 106 may press the element 816 to go back to the previous interface.

FIG. 8C illustrates an example embodiment of an interface diagram 800C of the application interface generated by the content processing system 102 according to the present disclosure. The application interface is an interface of the system application associated with the content processing system 102. The application interface may be presented on the display device 304 based on the content recommended by the ML model(s) 116.

Further, the application interface includes an element 818, an element 820, an element 822, an element, 824, and an element 826. The element 818 indicates a size of the frame selected by the user 106. For example, if the user 106 selects a frame of size 11 x 14 on the interface diagram 800B as illustrated in FIG. 8B, the interface diagram 800C renders the size 11 x 14 as the element 818. Similarly, the element 820 indicates a price of the selected frame. For example, if the price of the selected frame is $25, the interface diagram 800C renders $25 as the element 820.

The element 822 indicates options of distinctive styles of frames to be selected by the user 106. For example, the element 822 may include frames of different arrangements, such as a first arrangement in which one image is placed on top of the frame and two images are placed at the bottom of the frame, and a second arrangement in which two images are placed on the top of the frame and one image is placed at the bottom of the frame. The element 822 may further have the option to slide left or right to select a desired size and arrangement of the frame. In an embodiment, a price associated with a corresponding arrangement in the frame may also be shown on the display device 304.

The element 824 indicates an option to choose a color of a mat present in the frame. In one embodiment, the element 824 may be provided with multiple color options. The user 106 may tap on the color option desired to put on the frame as a mat.

The user 106 may select options rendered on the display device 304. For example, the user 106 may select the first arrangement in the element 822 and an ivory color in the element 824. After selecting the options, the user 106 may press the element 808 for further processing. Alternatively, the user 106 may press the element 816 to go back to the previous interface or the user 106 may press the element 826 to cancel the order anytime.

FIG. 8D illustrates an example embodiment of an interface diagram 800D of the application interface generated by the content processing system 102 according to the present disclosure. The application interface is an interface of the system application associated with the content processing system 102. The application interface may be presented on the display device 304 of the user device 104 based on content recommended by the ML model(s) 116.

Further, the application interface includes an element 828, an element 830, an element 832, and an element 834. The element 828 indicates a layout of the frame selected by the user 106. For example, if the user 106 has selected the first arrangement in the element 822 and the ivory color in the element 824 on the interface diagram 800C as illustrated in FIG. 8C, the interface diagram 800D renders a visual representation of the frame. Similarly, the element 820 indicates an overall price of the selected frame.

The element 830 indicates options of content to be present on the mat. For example, the element 830 may include an option for selecting indent of a text placed on the mat, an option to enter personalized text, an option to select an image to be placed on the mat.

The element 832 indicates an option to select an image obtained from sponsors or promoters. For example, the content processing system 102 may obtain high-definition images from the event promoter server(s) 112 and may provide to the user 106 for including these images in the frame.

The element 834 indicates an option to import images from the user device 104. In an aspect, the user 106 may capture images of players, selfies, images of friends and families, and a particular occasion during the event. The user 106 may include these images in the frame.

The user 106 may select options rendered on the display device 304. For example, the user 106 may select a center indentation, a text of “Tim Lincecum 1st Career No Hitter” and an image of event in the element 830. The user 106 may further select a sponsored image in the element 832 and an image from the library of the user device 104 in the element 834.

After selecting the options, the user 106 may press the element 808 for further processing. Alternatively, the user 106 may press the element 816 to go back to the previous interface or the user 106 may press the element 826 to cancel the order anytime.

FIG. 8E illustrates an example embodiment of an interface diagram 800E of the application interface generated by the content processing system 102 according to the present disclosure. The application interface is an interface of the system application associated with the content processing system 102. The application interface may be presented on the display device 304 based on content recommended by the ML model(s) 116.

Further, the application interface includes an element 836 and an element 838. The element 836 indicates a finalized frame selected by the user 106. After receiving user input on the options rendered on the display device 304, the content processing system 102 generates a finalized frame based on the user input. In an example, the user 106 may select the frame of the size 11 x 14 and color brown, select the first arrangement, select a mat of ivory color, provide a text “Tim Lincecum 1st Career No Hitter”, and three images recommended by the ML model(s) 116. The images can come from the user device 104, image databases, stock images, team/act content, or any other source. Based on the selection from the user, the content processing system 102 generates the finalized frame and renders it on the display in the element 836.

The element 838 indicates an order summary according to the content placed in the finalized frame. The order summary indicates individual price of every single content selected by the user 106. In addition, the order summary may comprise a total cost of the frame including the content selected by the user 106.

The user 106 may perform a final check before placing the order. After final checking, the user 106 may press the element 808 for further processing. Alternatively, the user 106 may press the element 816 to go back to the previous interface or the user 106 may press the element 826 to cancel the order anytime.

FIG. 8F illustrates an example embodiment of an interface diagram 800F of the application interface generated by the content processing system 102 according to the present disclosure. The application interface is an interface of the system application associated with the content processing system 102. The application interface may be presented on the display device 304 of the user device 104 based on content recommended by the ML model(s) 116.

Further, the application interface includes an element 840, an element 842, and an element 844. The element 840 indicates a total cost of the frame including the content selected by the user 106. As illustrated in FIG. 8F, the element 840 is shown as $65.10.

The element 842 indicates an option for providing an email address of the user 106 for sending an order confirmation. In an implementation, every single detail related to the order, such as order confirmation number and tracking details may be transmitted to the email address provided by the user 106 in the element 842.

The element 844 indicates an option for inputting payment details by the user 106. The element 844 comprises a selection tray for selecting a method of payment, such as credit card payment or unified Payment Interface (UPI) payment. The element 844 further comprises an input block for receiving card number, an input area for receiving name on the card, an input area for receiving expiration date, an input area for receiving Card Verification Value (CVV) number, and an input area for zip code.

The user 106 may perform a final check before placing the order. After final checking, the user 106 may press the element 808 for further processing. Alternatively, the user 106 may press the element 816 to go back to the previous interface or the user 106 may press the element 826 to cancel the order anytime.

FIG. 8G illustrates an example embodiment of an interface diagram 800G of the application interface generated by the content processing system 102 according to the present disclosure. The application interface is an interface of the system application associated with the content processing system 102. The application interface may be presented on the display device 304 based on the content recommended by the ML model(s) 116.

Further, the application interface includes an element 846, an element 848, and an element 850. The element 846 indicates an order confirmation for the user 106. As illustrated in FIG. 8G, the element 846 includes an order confirmation number and individual cost of every single item selected by the user 106.

The user 106 may perform a final check before placing the order. After final checking, the user 106 may press the element 848 for further printing a confirmation receipt or storing the confirmation receipt on the user device 104. Alternatively, the user 106 may press the element 850 to go back to a home page. In some embodiments, the content access pattern is in the shape of a brand logo, and the content access pattern is uniquely linked with the personalized content repository.

FIGS. 8H-8K illustrate exemplary frames created by the content processing system 102 according to an embodiment of the present disclosure. For example, FIG. 8H shows a frame 800H having a single image fetched from the user device 104 along with date of the event and a particular occasion (opening day) of the event. Apart from these contents, the frame 800H includes a logo of the team supported by the user 106. The logo may comprise the content access pattern.

FIG. 8I shows a frame 800I having an image of the user 106 (selfie fetched from the user device 104), an image indicating the event (banner of the event), date of the event, name of the event, and a logo of the brand. FIG. 8J shows a frame 800J having an image of a group of attendees related to the user 106, an image indicating a person who has a particular occasion, date of the event, name of the particular occasion (50th Birthday), and a caption/content provided by the user 106. FIG. 8K shows a frame 800K having an image of the user 106 along with his/her favorite player, an image indicating players of a team supported by the user 106, date of the event, name of the team supported by the user 106, and a logo of the team.

It must be understood that FIGS. 8H-8K are mere examples of the frame personalized for the user 106. The frame may have distinctive designs, colors, and contents, excluding the frames illustrated in FIG. 8H-8K.

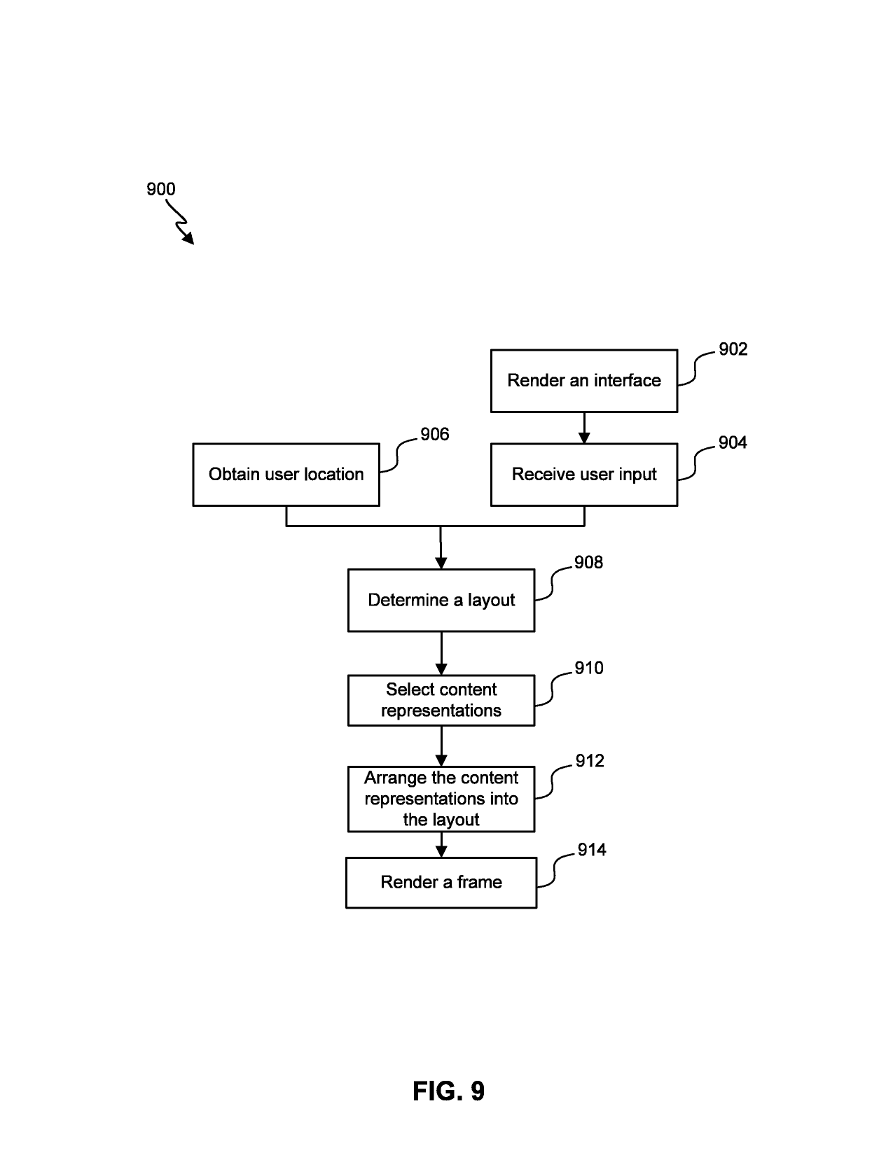

FIG. 9 illustrates a flowchart 900 for creating customized content representations related to the content source according to an embodiment of the present disclosure. Flowchart 900 explains an exemplary method to be executed by the content processing system 102 for creating the customized content related to the event. At step 902, the content processing system 102 renders multiple options related to the event to customize the content to create a frame, as illustrated in the interface diagram 800A of FIG. 8A. The options are pre-defined according to the type of event. The content may be rendered on the display device 304.

In an embodiment, the content may be selected using the ML model(s) 116. Details of training and usage of the ML model(s) 116 are described in detail in FIG. 9. The ML model(s) 116 obtains user information from the media channel(s) 108. The user information comprises at least one of the user preferences, the user characteristics, and the Personally Identifiable Information (PII). Examples of the media channels(s) may include but are not limited to social media channel, such as Facebook, Twitter (now X), Instagram, and so on.

For example, user 106 may update his/her stories of attending the event on social media. The content processing system 102 obtains these details from social media and provides the details to the ML model(s) 116. The ML model(s) 116 utilizes the details to determine the likes and/or dislikes of the user 106. Further, the ML model(s) 116 predicts content that could be presented to the user 106 based on his likes and/or dislikes. For example, if the event is a football match between two teams and the ML model(s)determines that the user 106 is a fan of “team A” playing in the event based on data obtained from the media channel(s) 108, the ML model(s) 116 suggests the content associated with team A to be displayed on the user device 104 associated with the user 106. Then, the method proceeds to step 904.

At step 904, the user input is received in response to the options displayed on the user device 104. The user input may be in a natural language. The user 106 may provide user input on the user device 104 with respect to the system application associated with the content processing system 102.

Parallelly, the content processing system 102 obtains geolocation of the user 106, at step 906. In an embodiment, the geolocation of the user 106 may be received from a positioning server, such as GPS. The geolocation of the user is obtained when the user 106 is present in the event. The content processing system 102 may utilize the geolocation of the user to determine a portion of the sitting area where the user 106 is present during the during. Then the method proceeds to step 908.

At step 908, the ML model(s) 116 may analyze the above-mentioned details (e.g., the user input and the geolocation) to determine a layout recommended to the user 106. For example, the ML model(s) 116 may select layouts of the frame as illustrated in the element 820 of the FIG. 8C. For example, using prior purchases of user 106, the ML model(s) 116 suggests similar layouts for user 106. Then, the method proceeds to step 910.

At step 910, the ML model(s) 116 selects content representations associated with that portion of the sitting area for recommending to the user 106. For example, the ML model(s) 116 may select images of the portion of the sitting area where user 106 is present during the event. In an alternate embodiment, the ML model(s) 116 may also predict a team in the event supported by user 106 based on the portion of the sitting area where user 106 is present. In an embodiment, the content representations comprise poster of the event, a logo associated with the event, branding associated with the event, event information, and customized text provided by the user 106. Then, the method proceeds to step 912.

At step 912, the content processing system 102 arranges the content representations to fill into the layout. For example, the content processing system 102 may re-size and re-arrange to fit the content representations into the desired location of the frame. For example, if the user 106 has selected a layout in which an image of the user 106 is expected to be present in corner of the frame with a size of 3 x 4, the content processing system 102 may re-size and re-arrange the image of the user 106 to fit into the corner of the frame with the size of 3 x 4. Then, the method proceeds to step 914.

At step 914, the content processing system 102 renders the frame with content representations selected by the user 106. In an embodiment, the frame rendered on the display device 304. As illustrated in FIG. 8E, the element 836 is the final frame rendered on the display device 304. The user 106 may confirm an order of the frame through the user device 104. After confirmation, the content processing system 102 provides the frame to a printing device (not illustrated) to print the frame.

Various embodiments could have a content processing system 102 to print, frame, and ship or could use third party framing and printing services. The fulfilment could be selectable if there are multiple options or the system could choose the appropriate fulfilment based upon costs, capabilities, and speed. An API to the various fulfilment systems could be used to send the information wanted to produce the print frame.

In an embodiment, the content processing system 102 may transmit configuration of the frame to a third-party platform, such as KeepSake™ for creating an unshared frame personalized to the user 106. For example, the content processing system 102 may generate configuration of the frame based on the user input received from the user device 104. The configuration indicates parameters, such as positioning of the contents selected by the user, a size of the frame, a layout of the frame, and so on. The third-party platform utilizes the configuration of the frame to create the personalized frame for the user 106.

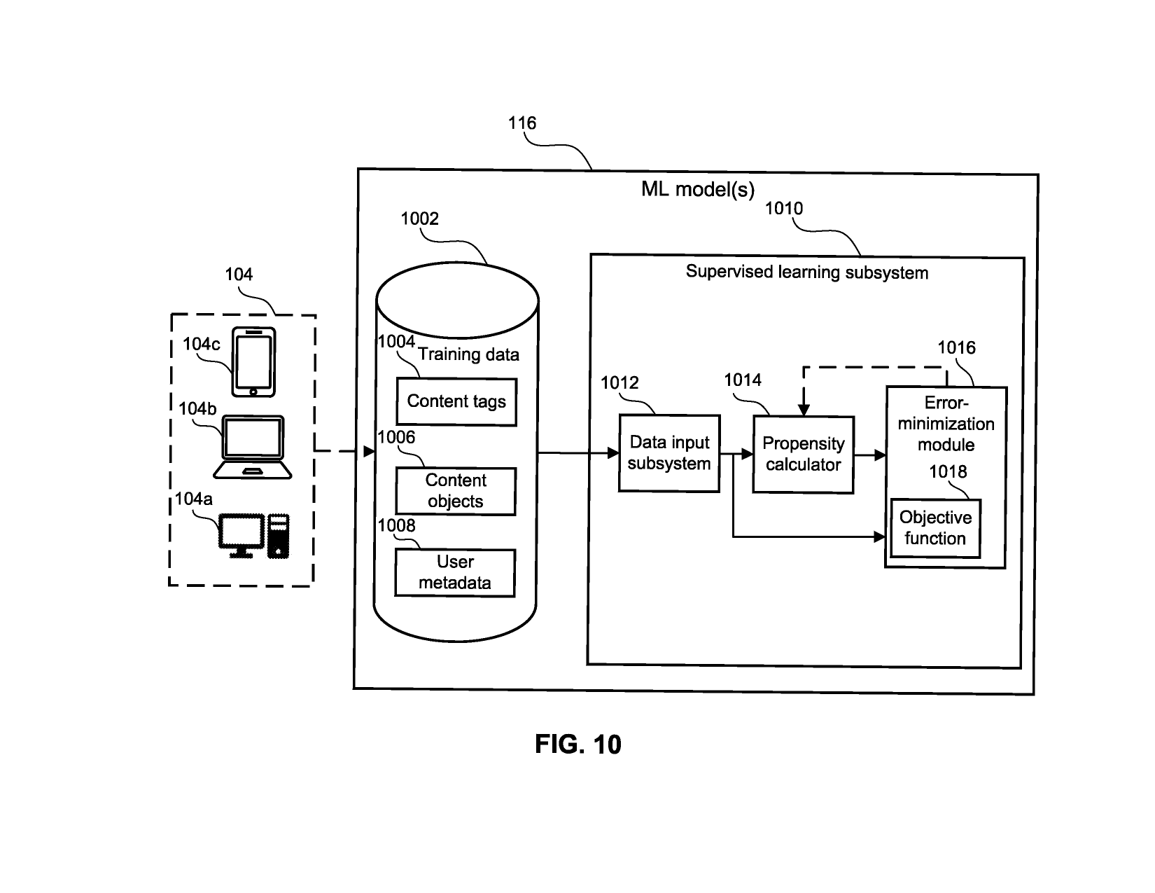

FIG. 10 illustrates a block diagram of the ML model(s) 116 according to an embodiment of the present disclosure. More specifically, in some embodiments, the ML model(s) 116 may be trained using training data 1002. The training data 1002 may be populated by data received from the user device 104 and data sources associated with the content processing system 102. As described above, the ML model(s) 116 may be or include a non-binary classifier, such as a multinomial logistic regression model implemented in a neural network, trained to predict a probability that an input can be mapped to classes of a set of classes, corresponding to content tags 1004 or user characteristics from user metadata 1008.

As such, training the ML model(s) 116 may include applying a supervised learning technique using labeled sets of training data 1002, which may include content tags 1004, content objects 1006, and user metadata 1008. The user metadata 1008 may include user characteristics or other identifiers, such as anonymized identification numbers. The content tags 1004 may be drawn from a database of features that the ML model(s) 116 are trained to identify. As such, the content tags 1004 may correspond to the features that may characterize content objects processed by the ML model(s) 116. The user device(s) 104 includes at least one of a computer system 104a, a laptop 104b, and a smart phone 104c.

The training data may be provided to a supervised learning subsystem 1010. For example, the supervised learning subsystem 1010 may comprise a data input subsystem 1012 to receive the training data 1002. As part of supervised training, the supervised learning subsystem 1010 may use the training data 1002 to define a ground truth, such that elements defining a mapping of the content tags 1004 and user characteristics from the user metadata 1008 are provided to a propensity calculator 1014 and an error-minimization module 1016. The error-minimization module 1016 may, in turn, implement an objective function 1018, which may be an error function, for example, defined as a distance between the model output and the ground truth. In this way, training may include adjusting weights and/or coefficients of the propensity calculator 1014 over multiple iterations until the value of the objective function converges toward the least.

In some embodiments, the input to the propensity calculator 1014 includes the characteristics of a set of users, and the output includes a vector of probability values corresponding to predicted content features. In this way, the propensity calculator 1014 may be trained to map the content tags 1004 of the training data 1002 to the user metadata 1008 of the training data 1002, and, once trained, the propensity calculator 1014 may be used to generate the propensity score. As trained, the propensity calculator may be able to determine the propensity score indicative of the extent to which the user has a propensity for releasing the user’s data to digital platform.

In some embodiments, the supervised learning subsystem 1010 may implement hyperparameter tuning, in addition to supervised learning, to optimize the ML model(s) 116. For example, terms of the objective function 1018 and/or the ML model(s) 116 may be fine-tuned by varying parameters that are not learned, such as scalar weighting factors.

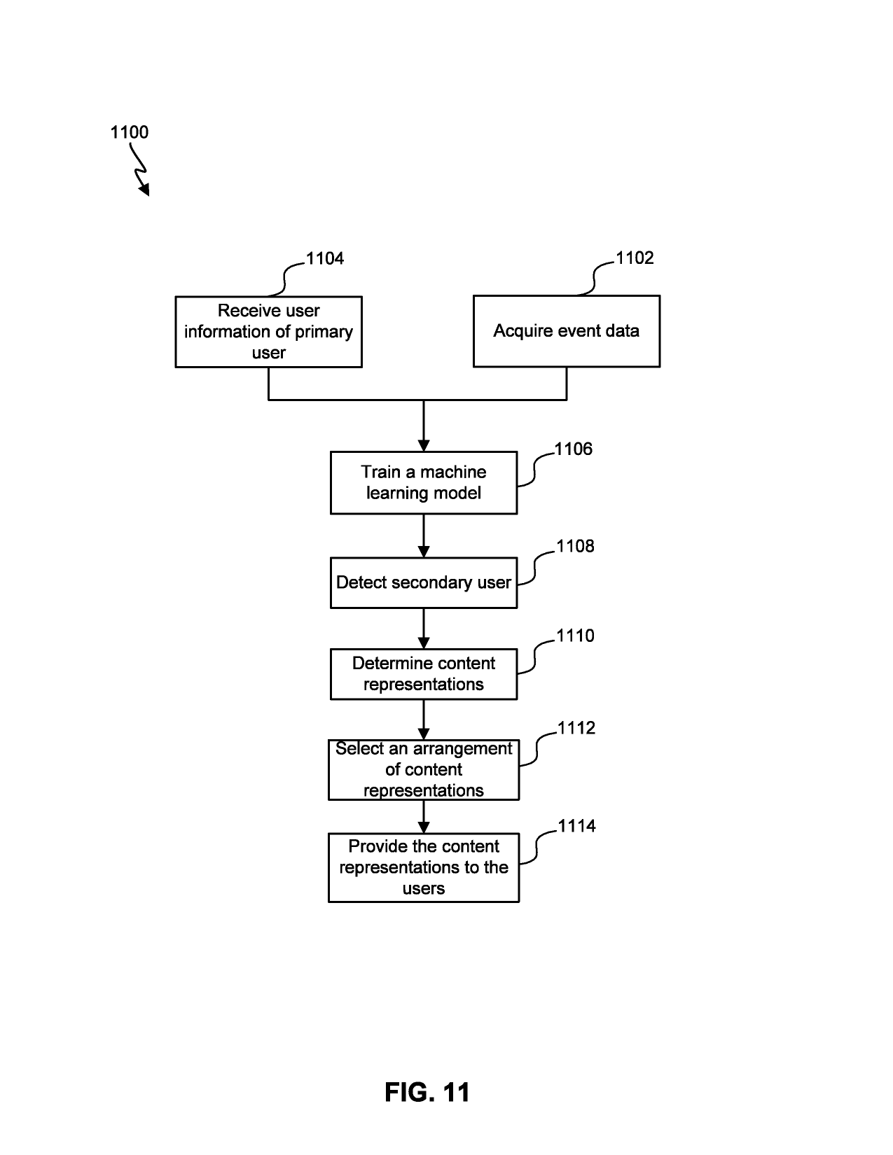

FIG. 11 illustrates a flowchart 1100 for selecting content representations related to a content source for the user 106 according to an embodiment of the present disclosure. Flowchart 1100 explains an exemplary method to be executed by the content processing system 102 for creating customized content related to an event. At step 1102, the content processing system 102 acquires data related to the event. In an embodiment, data may be acquired from a shared memory storing every single data related to the event, such as images associated with the event. In an alternate embodiment, data may be acquired from the media channel(s) 108. Examples of the media channels(s) may include, but are not limited to, a social media channel, such as Facebook, Twitter, Instagram, and so on. For example, attendees of the event may upload images of the event on social media. The content processing system 102 may acquire those images from social media. In yet another embodiment, the promoters/sponsors of the event may store every single data related to the event on a central server and may provide access to the central server to the content processing system 102. The content processing system 102 may acquire relevant data and/or images from the central server (as illustrated as event promoter server(s) 112). Then, the method proceeds to step 1104.

At step 1104, user information is received from the media channel(s) 108. The ML model(s) 116 obtains the user information from the media channel(s) 108. The user information comprises the user preferences, the user characteristics, and the PII. Examples of the media channel(s) 108 may include, but are not limited to, a social media channel, such as Facebook, Twitter (now X), Instagram, and so on. In some embodiments, the user information may comprise other information related to the event and the user. For example, geolocation of the user during the event and prior purchases of items. Then, the method proceeds to step 1106.

At step 1106, the ML model(s) 116 are trained or updated using data related to the event and the user information. Training of the ML model(s) 116 is described in detail through FIG. 10. For example, the user 106 may update stories or posts related to attending the event on social media. The content processing system 102 obtains these details from social media and provides the details to the ML model(s) 116. The ML model(s) 116 may be trained on the data as illustrated in FIG. 10. The ML model(s) 116 further utilize the details to determine like and/or dislikes of the user 106. Further, the ML model(s) 116 predict content that could be presented to the user 106 based on the user’s 106 likes and/or dislikes. For example, if the event is a football match between two teams and the ML model(s) determine that user 106 is a fan of “team A” playing in the event based on data obtained from the media channel(s) 108, the ML model(s) 116 suggest the content associated with team A be displayed on the user device 104 associated with the user 106. Then, the method proceeds to step 1108.

At step 1108, the ML model(s) 116 may detect secondary users who attended the event along with the primary user (such as user 106). The detection is performed by analyzing data received from the shared database, the media channel(s) 108, and the event promoter server(s) 112. For example, the ML model(s) 116 may fetch the ticket purchased for the event by the user 106 and may determine the number of attendees with the user 106. In another example, the ML model(s) may fetch the images uploaded by the user 106 to determine the secondary users present in the event, along with the user 106. The secondary user may be a relative or a friend. Then, the method proceeds to step 1110.

At step 1110, the ML model(s) 116 select content representations associated with the secondary users. For example, the ML model(s) 116 may select images in which the user 106 is present along with the secondary users during the event. In an alternate embodiment, the ML model(s) 116 may also predict a team in the event supported by the user 106 based on the outfits of user 106 and the secondary user. In an embodiment, the content representations comprise of a poster of the event, a logo associated with the event, branding associated with the event, event information, and customized text provided by the user 106. The content representations can be interchangeably termed as content. Then, the method proceeds to step 1112.

At step 1112, the content processing system 102 selects an arrangement from pre-defined arrangements of content to fill into a layout of the frame. For example, the content processing system 102 may re-size and re-arrange to fit the content into the desired location of the frame. For example, if the user 106 has selected a layout in which an image of the user 106 is positioned in a corner of the frame with a size of 3 x 4, the content processing system 102 may re-size and re-arrange the image of the user 106 to fit into the corner of the frame with the size of 3 x 4. Then, the method proceeds to step 1114.

At step 1114, the content processing system 102 renders the frame with content representations selected by the user 106. For example, the content selected by the user 106 is provided to the primary user for selection. In an embodiment, the frame rendered on the display device 304. As illustrated in FIG. 8E, the element 836 is the final frame rendered on the display device 304.

The present disclosure further utilizes a digital twin of the user 106 to provide the content to the user 106 in a more interactive way. The digital twin is a digital informational construct about a machine, physical device, system, process, person, etc. Once created, the digital twin can be used to represent the user 106 in a digital representation of a real-world system. The digital twin is created such that it is identical in form and behavior of the corresponding user. Additionally, the digital twin may mirror the status of the user 106 within a greater system. Data related to user 106 may be gathered by the content processing system 102 to capture real-time (or near real-time) data from user 106 to relay it back to a remote digital twin.

For example, data related to height of the user 106, the weight of the user 106, the skin tone of the user 106, and so on, is obtained from the user 106 or an account of the media channel(s) 108. In addition, photos of the user 106 may be obtained from the media channel(s) 108 or the shared memory of the user device 104 associated with the user 106. Using this information, the ML model(s) 116 may create a 3D virtual object that simulates or mimics the behavior of the user 106 in a virtual world, such as the application associated with the content processing system 102.

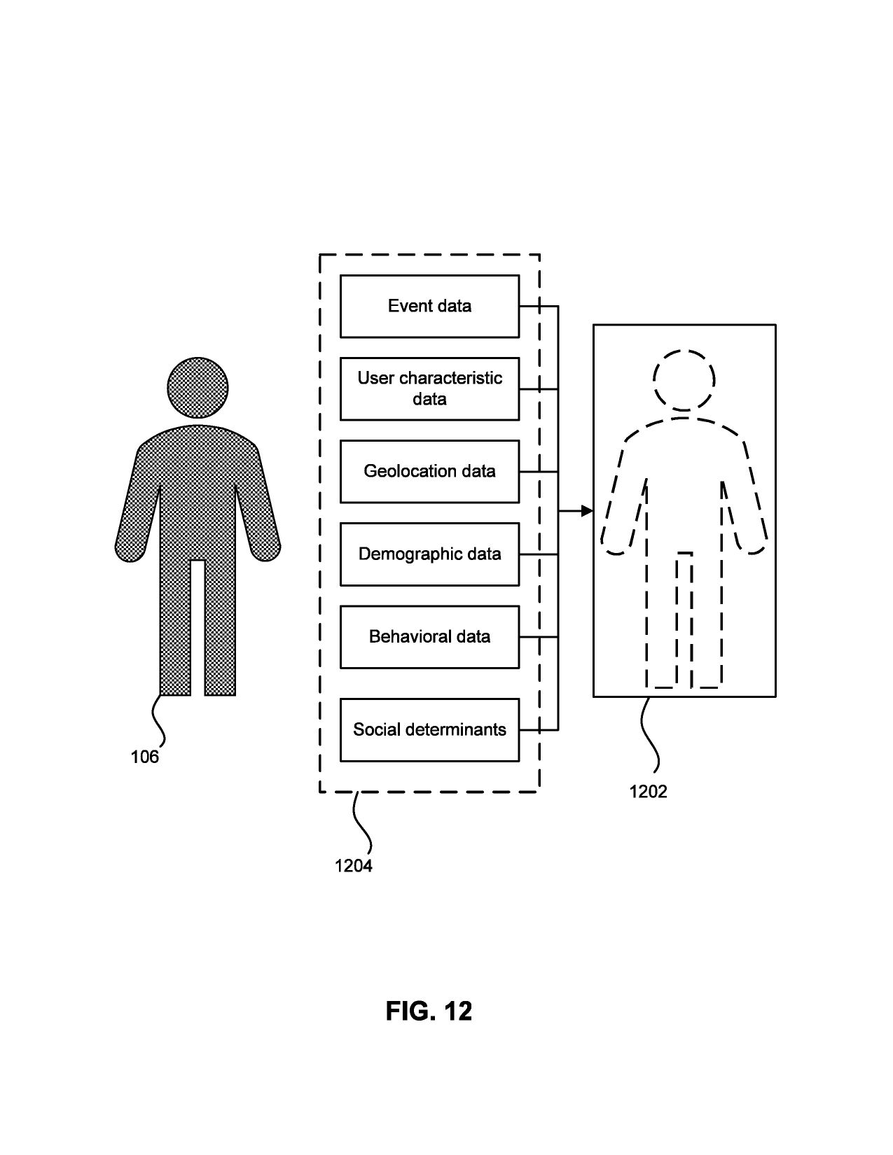

FIG. 12 illustrates a block diagram showing formation of a digital twin 1202 of the user 106 according to an embodiment of the present disclosure. The digital twin 1202 is constructed by the ML model(s) 116 using information 1204 associated with the user 106. In an embodiment, the information 1204 associated with the user 106 may be event data, data related to user characteristic, data related to geolocation, demographic data, behavioral data, and social determinants. For example, the content processing system 102 may access the user device 104 to obtain data related to height of the user 106, weight of the user 106, and skin tone of the user 106. Further the content processing system 102 may obtain images of the user 106 captured from different angles. Further, the content processing system 102 provides these details to the ML model(s) 116 for further processing.

The ML model(s) 116 are trained and fine-tuned to predict human behavior and physical structure of a human based on data related to the user. Further, the ML model(s) 116 determine the digital twin 1202 of the user 106 based on the behavior of the user 106 and the physical structure of the user 106. For example, the ML model(s) 116 may create a 3D structure which simulates or mimics the behavior of the user 106 in a virtual world, such as the application associated with the content processing system 102.

Further, the content processing system 102 utilizes the digital twin 1202 of the user 106 to recommend content on the user device 104. For example, the content recommended for the user 106 is integrated with the digital twin 1202 of the user 106 and rendered to the user 106. In this way, the recommended content becomes more attractive and personalized to the user 106.

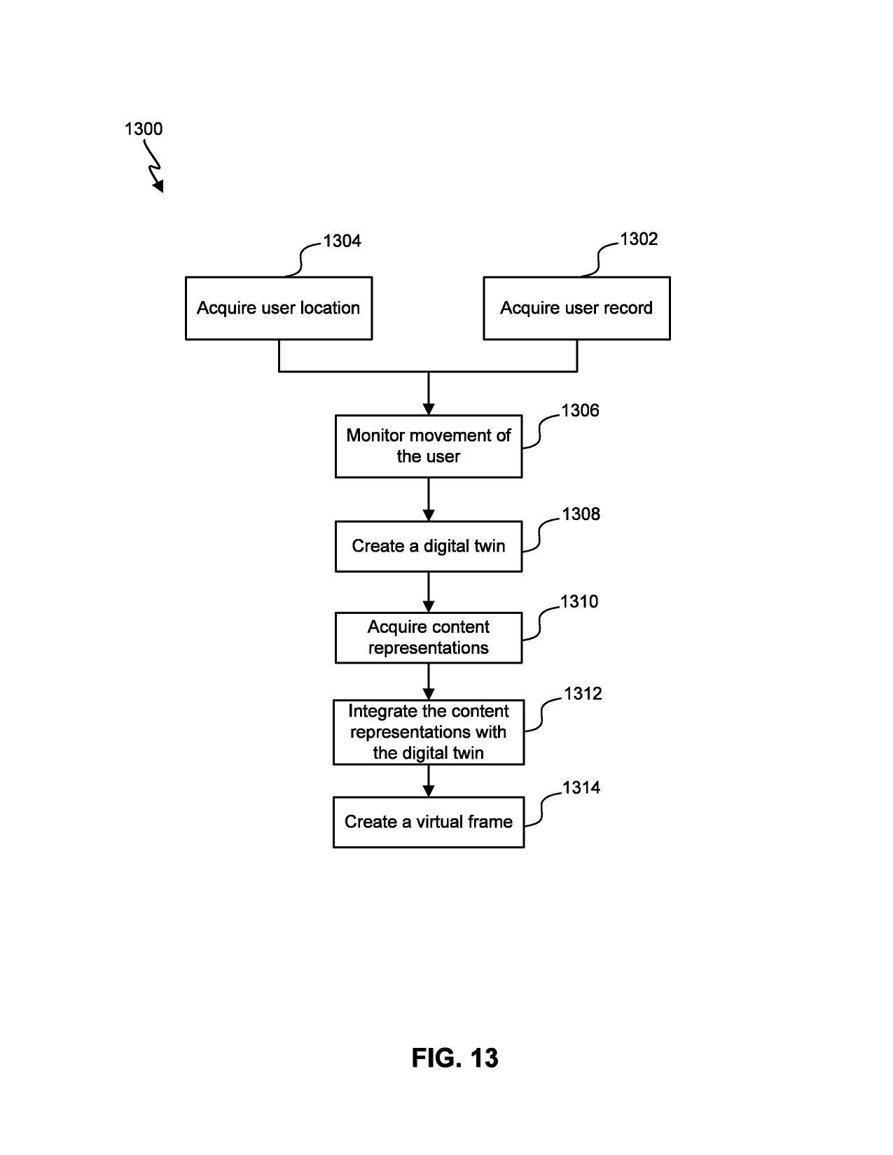

FIG. 13 illustrates a flowchart 1300 for creating a virtual frame according to an embodiment of the present disclosure. Flowchart 1300 explains an exemplary method to be executed by the content processing system 102 for creating customized content related to the event. At step 1302, the content processing system 102 acquires user information from multiple sources, such as a shared memory of the user device 104, the event promoter server(s) 112, and the media channel(s) 108. The user information may include user profile data, behavioral data, demographic data, and event-related interaction data. For example, the content processing system 102 may access the user device 104 to obtain data related to height of the user 106, weight of the user 106, and skin tone of the user 106. Further the content processing system 102 may obtain images of the user 106 captured from different angles. Then, the method proceeds to step 1304.

At step 1304, the content processing system 102 obtains the geolocation of the user 106. In an embodiment, the geolocation of the user 106 may be received from the positioning server, such as global positioning system (GPS). The geolocation of the user 106 is obtained when the user 106 is present in the event. The content processing system 102 may utilize the geolocation of the user to determine a portion of the sitting area where the user 106 is present during the event. Then the method proceeds to step 1306.

At step 1306, the ML model(s) 116 monitor the movement of user 106 based on the geolocation of the user 106. The movement may be monitored during the event. Then, the method proceeds to step 1308.

At step 1308, the digital twin 1202 of the user 106 is created. The digital twin 1202 is created based on the movement of the user 106 and the user information. In an embodiment, the digital twin 1202 may be created according to the process illustrated in FIG. 12. The digital twin 1202 simulates or mimics the behavior of the user 106 in a virtual world, such as the application associated with the content processing system 102. Then, the method proceeds to step 1310.

At step 1310, the ML model(s) 116 select the content based on the user information. For example, the ML model(s) 116 may select images of the user 106 during the event. In an alternate embodiment, the ML model(s) 116 may also predict a team in the event supported by the user 106 based on the user information. In an embodiment, the content comprises a poster of the event, a logo associated with the event, branding associated with the event, event information, and customized text provided by the user 106. Then, the method proceeds to step 1312.

At step 1312, the content processing system 102 integrates the content with the digital twin 1202. For example, the content may be virtually combined with the digital twin 1202 to provide an immersive experience of the event to the user 106. The digital twin 1202 of the user 106 together with AI/ML models can be used in choosing precise content personalized to the user 106. A virtual human model could also be used in a simulation for testing the content. Then, the method proceeds to step 1314.

At step 1314, the content processing system 102 renders a virtual frame on the display device 304 associated with the user 106. The virtual frame is created based on the integrated digital twin 1202.

The marketing/programming around the event is used to customize the recommendations. For example, event attributes, such as a first game attendance, opening day participation, premium seat attendance, season ticket holder status, alumni participation, junior participant designation, or a debut of a player may be incorporated into the recommended content. The ML model(s) 116 analyze the images of the user 106 to predict team by viewing at the apparel of the user 106. The images may be obtained from the user device 104 associated with the user 106. Further, other occasions, such as records broken that day or other notable things, can be added to the frame. There could be collector frames or matting too in line with the theme.

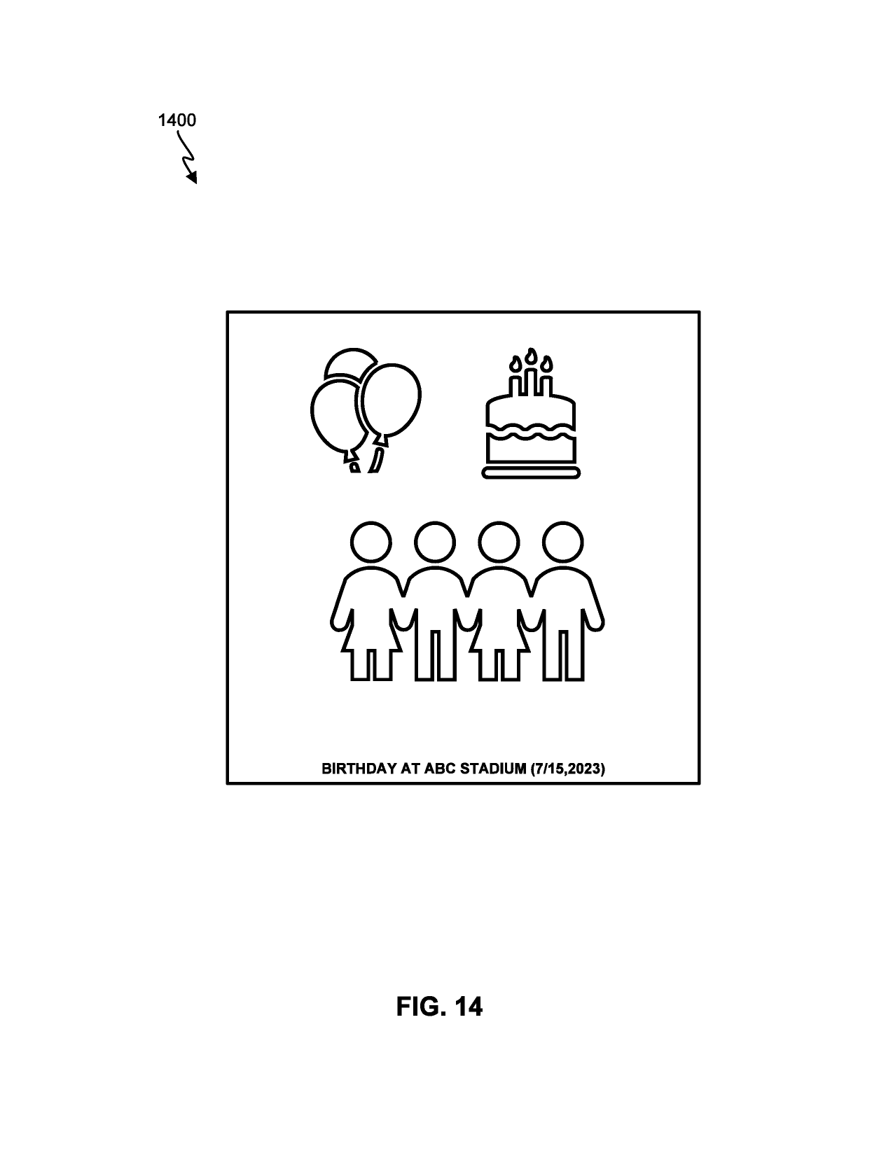

FIG. 14 illustrates a frame 1400 having images of the particular occasion, such as birthday image, according to an embodiment of the present disclosure. In addition, the content processing system 102 may include the venue and date of the event. The user 106 may select a layout to be used in the frame 1400.

In an embodiment, sponsors or promoters can give some or every single attendee of the event. Default gift frame has branding sponsors. Further, additional cost may be charged to upgrade and/or customize the content in the frame 1400.

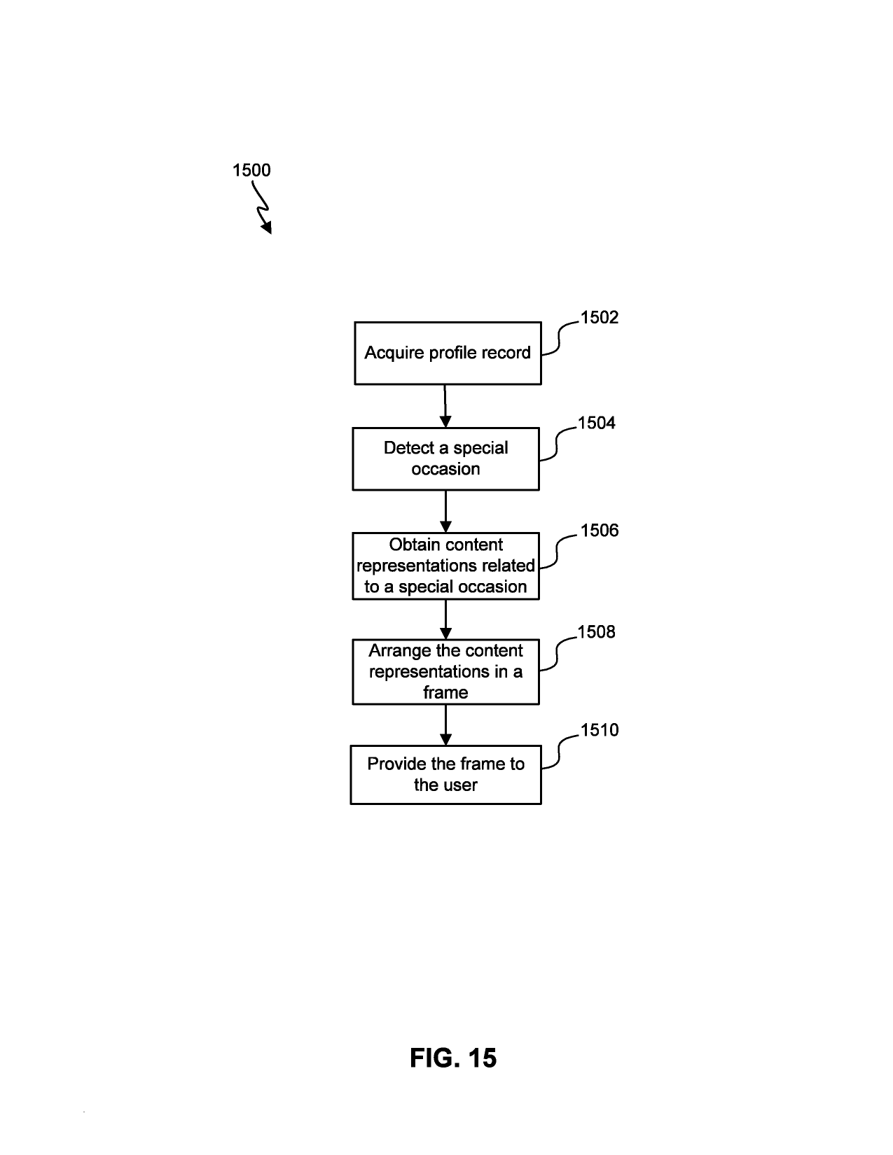

FIG. 15 illustrates a flowchart 1500 for providing the virtual frame to the user 106 according to an embodiment of the present disclosure. Flowchart 1500 explains an exemplary method to be executed by the content processing system 102 for creating the customized content related to the event. At step 1502, the content processing system 102 acquires a user record or a profile record. The user record includes data related to the event and the user information. In an embodiment, data may be acquired from a shared memory storing every single data related to the event, such as images associated with the event. In an alternate embodiment, data may be acquired from the media channel(s) 108. Examples of the media channels(s) may include, but are not limited to, a social media channel, such as Facebook, Twitter (now X), Instagram, and so on. For example, attendees of the event may upload images of the event on social media. Content processing system 102 may acquire those images from social media. In yet another embodiment, the promoters/sponsors of the event may store every single data related to the event on a central server and may provide access to the central server to the content processing system 102. The content processing system 102 may acquire relevant data and/or images from the central server (as illustrated as event promoter server(s) 112).

In an embodiment, the user information is received from the media channel(s) 108. The ML model(s) 116 obtain the user information from the media channel(s) 108. The user information comprises the user preferences, the user characteristics, and the PII. Examples of the media channels(s) may include, but are not limited to, a social media channel, such as Facebook, Twitter (now X), Instagram, and so on. Then, the method proceeds to step 1504.

At step 1504, the ML model(s) 116 detect a particular occasion associated with the event. The ML model(s) 116 are trained or updated using data related to the event and the user information. The user 106 may update his/her stories of attending the event on the social media. The content processing system 102 obtains these details from the social media and provides the details to the ML model(s) 116. The ML model(s) 116 may be trained on these data as illustrated in FIG. 10. For example, the ML model(s) 116 may be trained on data related to identification of an occasion based on at least one of images, apparel mood of a person in an image, and a location of the event. The ML model(s) 116 further utilize the details to detect a particular occasion in the event, such as a birthday party. Further, the ML model(s) 116 predict content that could be presented to the user 106 based on the particular occasion.

At step 1506, the ML model(s) 116 select content associated with the particular occasion. For example, the ML model(s) 116 may select images in which the user 106 is celebrating the birthday party, as illustrated in 1400 of FIG. 14. Then, the method proceeds to step 1508.

At step 1508, the content processing system 102 selects an arrangement of the content to fill into a layout of the frame. For example, the content processing system 102 may re-size and re-arrange to fit the content into the desired location of the frame. For example, if the user 106 has selected a layout in which an image of the user 106 is expected to be present in a corner of the frame with a size of 3 x 4, the content processing system 102 may re-size and re-arrange the image of the user 106 to fit into the corner of the frame with the size of 3 x 4. Then, the method proceeds to step 1510.

At step 1510, the content processing system 102 renders the frame with content selected by the user 106. In an embodiment, the frame is rendered on the display device 304. As illustrated in FIG. 8E, the element 836 is the final frame rendered on the display device 304.

In some embodiments, the ML model(s) 116 may recommend content having royalties to the IP holders. When these contents are provided as options to the user 106 and the user 106 selects these contents, the cost to the user 106 may change depending upon royalties to be given to the IP holders. For example, the user 106 may select a logo of a brand, photos of players of a team, team photos, and so on. In such cases, the overall cost of the frame may increase. The content processing system 102 obtains a cost associated with every single selected content item based on an applicable royalty structure. Based on the cost of every single content, the content processing system 102 calculates the overall cost of the frame.

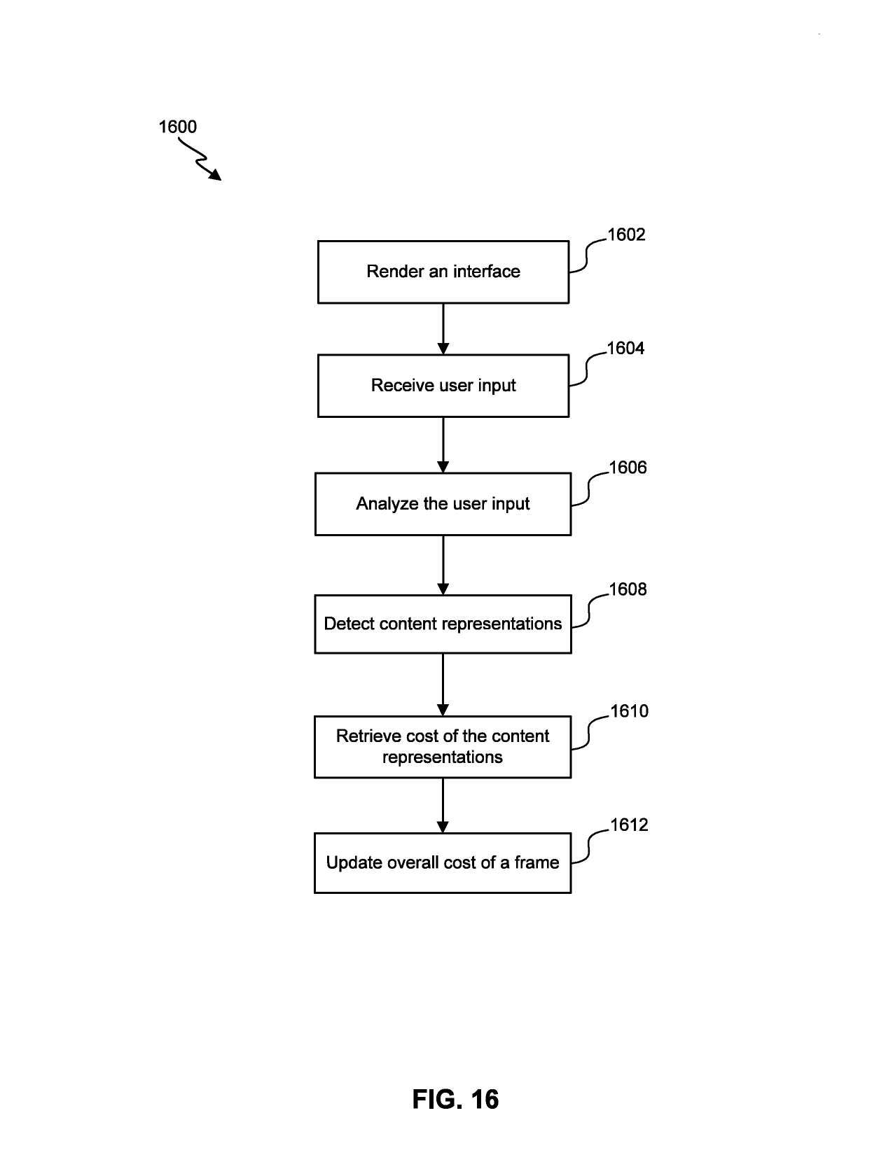

FIG. 16 illustrates a flowchart 1600 for managing cost to a user 106 against the content related to the event according to an embodiment of the present disclosure. Flowchart 1600 explains an exemplary method to be executed by the content processing system 102 for creating customized content related to the event. At step 1602, the content processing system 102 renders multiple options related to the event to customize content for generation of the frame, as illustrated as the interface diagram 800A of FIG. 8A. The options are pre-defined according to the type of the event. The content may be rendered on the display device 304. In an embodiment, the content may be selected using the ML model(s) 116. Details of training and usage of the ML model(s) 116 are described in detail through FIG. 10. The ML model(s) 116 obtains the user information from the media channel(s) 108. The user information comprises the user preferences, the user characteristics, and the PII.

Examples of the media channels(s) 108 may include, but are not limited to, a social media channel, such as Facebook, Twitter, Instagram (now X), and so on. For example, the user 106 may update his/her stories of attending the event on the social media. The content processing system 102 obtains these details from the social media and provides the details to the ML model(s) 116. The ML model(s) 116 utilize the details to determine like and/or dislikes of the user 106. Further, the ML model(s) 116 predict content that could be presented to the user 106 based on his likes and/or dislikes. For example, if the event is a football match between two teams and the ML model(s) 116 determines that the user 106 is a fan of “team A” playing in the event based on data obtained from the media channel(s) 108, the ML model(s) 116 suggest the content associated with team A to be displayed on the user device 104 associated with the user 106. In some embodiments, some of the content may be associated with royalties to IP holders. Then, the method proceeds to step 1604.

At step 1604, the user input is received in response to the options displayed on the user device 104. The user input may be in a natural language. The user 106 may provide user input on the user device 104 with respect to the system application associated with the content processing system 102. For example, the user 106 may select a logo of a brand, photos of players of a team, team photos, and so on. Then the method proceeds to step 1606.

At step 1606, the ML model(s) 116 may analyze the user input to identify the content for the user 106. For example, the ML model(s) 116 may collect every single user input obtained through the interface diagram 800A through 800D and may analyze the user inputs. Then, the method proceeds to step 1608.

At step 1608, the ML model(s) 116 select content associated with the user input. For example, the ML model(s) 116 may obtain images selected by the user 106 associated with the user device 104. In an alternate embodiment, the ML model(s) 116 may also recommend the content related to the selected by the user 106. The content may be associated with the authority to an individual or a corporation. Then, the method proceeds to step 1610.

At step 1610, the content processing system 102 retrieves an amount of royalty of every single content selected by the user 106. In an embodiment, the amount of the royalty may be obtained from the corresponding IP holder of the content. Further, the content processing system 102 determines cost of every single content selected by the user 106. The cost of every single content is determined based on the amount of royalty of every single content. Then, the method proceeds to step 1612.

At step 1612, the content processing system 102 updates the overall cost of the frame including the content selected from the user 106. For example, the content processing system 102 calculates the overall price of the frame by adding the cost of individual content selected by the user 106. The overall cost may be rendered on the display device 304 associated with the user 106, as illustrated by the element 838 on the interface diagram 800E illustrated in FIG. 8E. The user 106 may confirm an order of the frame through the user device 104. After confirmation, the content processing system 102 provides the frame to a printing device (not illustrated) to print the frame.

In some embodiments, at every event, there are artifacts from the performance that can be included in the framed item, for example, smashed guitar bits or game-used balls. Additionally, merchandise sold in the shops can be integrated, for example, concert shirts and team jerseys. These can be optionally added in the collage with a certificate of authenticity from the team/promoter. Upgrade options might be possible to have the artifact autographed. Numbered prints of the concert/tour poster could be offered or even the original art. The home run ball could be offered. Pedigree with tracking and authentication could be guaranteed by the sports club. The proper framing or shadow box to fit the artifacts and photos are to be chosen.

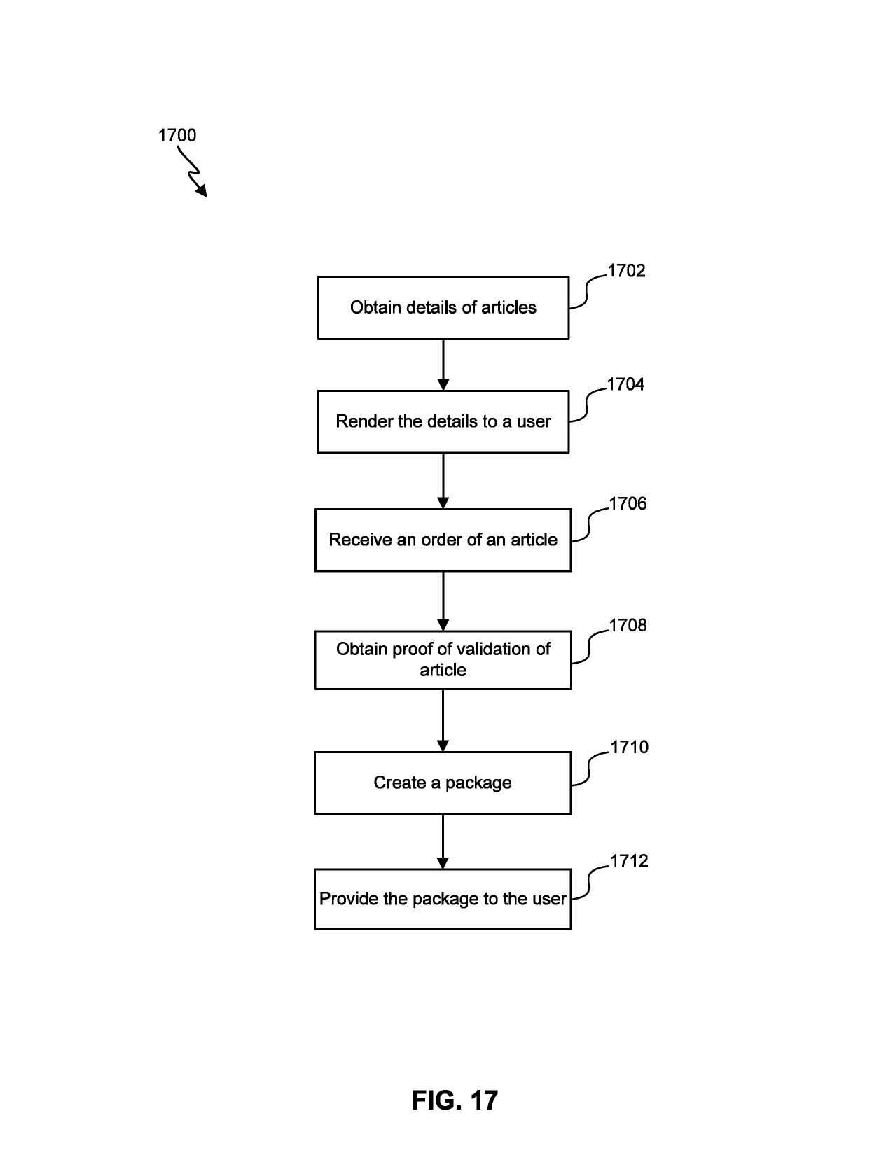

FIG. 17 illustrates a flowchart 1700 for providing a package to the user 106 according to an embodiment of the present disclosure. Flowchart 1700 explains an exemplary method to be executed by the content processing system 102 for creating the customized content related to the event. At step 1702, the content processing system 102 obtains details of the articles present during the event. The articles may be available for distribution. The details are obtained from multiple sources including images of the event, details of artifacts from a performance in the event, and collection of other items associated with the event. For example, the content processing system 102 may obtain cost of every single artifact, such as smashed guitar bits, game-used balls, merchandise (concert shirts and team jerseys), and numbered prints of the concert/tour poster. Then, the method proceeds to step 1704.

At step 1704, the details of the articles are rendered on the interface of the application associated with the content processing system 102. For example, the content processing system 102 renders images of the articles related to the event as options to the user 106. The details may include multiple parameters, such as cost of the article, dimensions of the article, a frame in which the article may fit, and so on. Then, the method proceeds to step 1706.

At step 1706, the content processing system 102 receives an order against the options provided by the ML model(s) 116. The order comprises indication of articles to be provided in the frame. The selection of the articles may be provided based on the dimension of the article and space available in the frame, such that the article is fitted in the frame. Then, the method proceeds to step 1708.

At step 1708, the content processing system 102 may obtain the certificate of authenticity of every single article selected by the user 106 associated with the user device 104. The certificate of authenticity ensures that the article is authentic. The certificate of authenticity may be provided by the promoters/sponsors of the event. Alternatively, the certificate of authenticity may be provided by the owner of the specific article. Then, the method proceeds to step 1710.

At step 1710, the frame or the package is created. The frame is formed by integrating the articles selected by the user 106. The article is integrated into the frame according to the dimension of the article and the dimension and layout of the frame. In some examples, the frame is formed by integrating the article and the certificate of authenticity. Different layouts of the frame may be illustrated in element 822 of FIG. 8C. Then, the method proceeds to step 1712.

At step 1712, the frame including the articles selected by the user 106 is provided to the user 106. In such way, the user 106 can purchase authentic articles after the completion of the event.

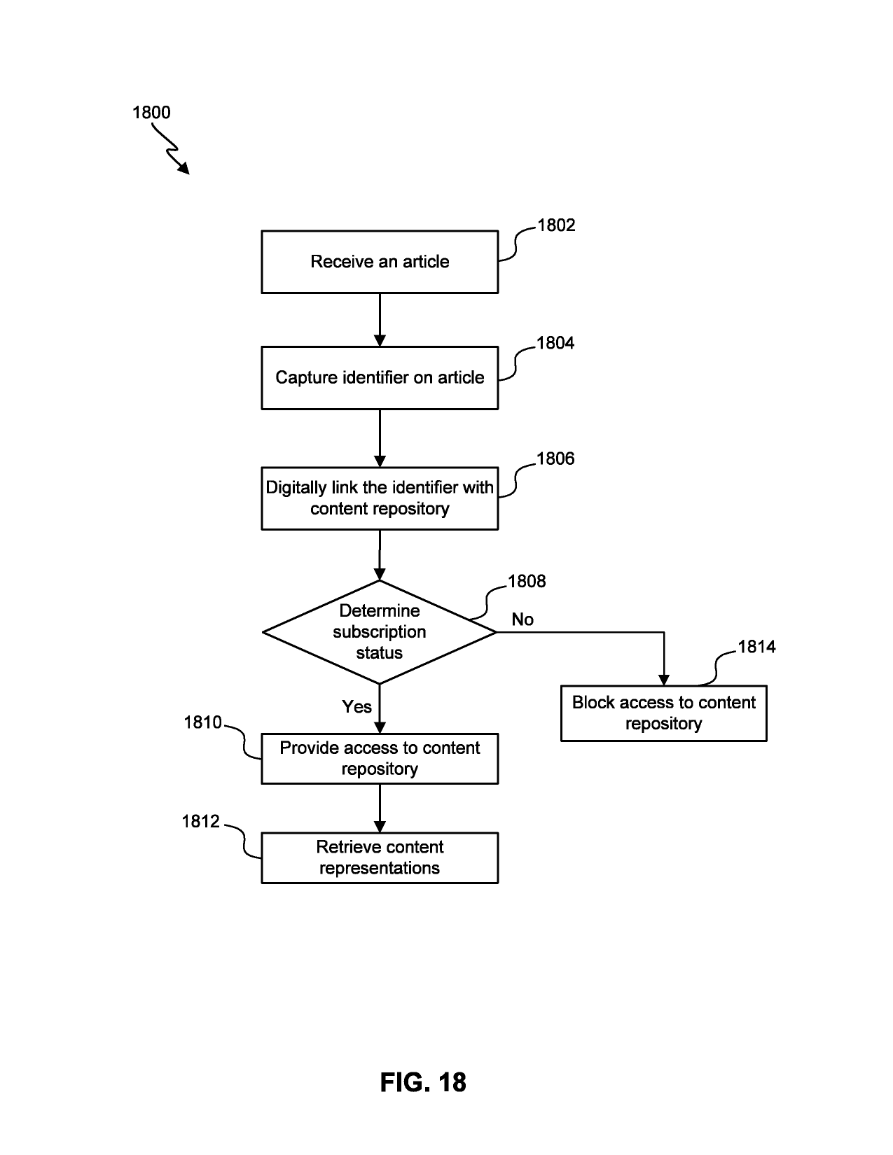

FIG. 18 illustrates a flowchart 1800 for controlling access to the content repository associated with the content access pattern according to an embodiment of the present disclosure. The flowchart 1800 explains an exemplary method executed by the content processing system 102 in cooperation with the identifier manager 118 and the access controller 416 to provide controlled access to the digital assets associated with the article using identity-based access control mechanisms.

At step 1802, the content processing system 102 receives the article. The article may be a physical item associated with the event, such as a framed artifact, merchandise item, printed media, or memorabilia. The article includes the content access pattern, or the article is associated with the content access pattern that enables digital interaction with users. In some embodiments, the content access pattern is matchlessly generated and cryptographically associated with a digital identifier corresponding to the article and/or the subscribed profile.

At step 1804, the content access pattern present on the article is captured using the user device 104, such as a mobile phone or scanning device. The content access pattern may include a barcode, QR code, or other machine-readable graphics that store or references access information. The captured pattern is transmitted to the content processing system 102 via the data communication network(s) 114.

At step 1806, the content processing system 102 digitally links the content repository associated with the captured content access pattern. The content repository may store digital media related to the article or the event. The digital media may include images, videos, audio files, certificates of authenticity, or personalized event content. The linking enables the content access pattern to act as an access key for the content repository. In some embodiments, the linking process includes verifying a digital signature or token associated with the content access pattern to prevent unauthorized duplication.

At step 1808, the access controller 416 determines the subscription status of the user 106 attempting to access the content repository. The access controller 416 determines whether the user is authorized or not. The subscription status may indicate whether the user 106 has an active subscription, limited access rights, trial access, or no subscription. The subscription information may be retrieved from the cloud-hosted platform 120 or a subscription database. In an exemplary embodiment, the access controller 416 dynamically updates the content repository over time based on a subscription status of the subscribed profile or based on ownership transfer of the associated article.

If the subscription status indicates that the user 106 is authorized, the 1800 method proceeds to step 1810. At step 1810, access to the content repository is provided. The user 106 is granted permission to view, stream, or download the digital media stored in the content repository based on the subscription level.

At step 1812, the digital media is retrieved from the content repository and delivered to the user device 104. The digital media may be retrieved through a secure session and presented via an application or web interface associated with the content processing system 102. In some embodiments, access is time-bound, device-bound, geo-restricted, or usage-limited based on predefined access policies.

If the subscription status determined at step 1808 indicates that the user 106 is not authorized, the method proceeds to step 1814. At step 1814, access to the content repository is blocked. The user may be prompted to subscribe, authenticate, or upgrade an existing subscription to gain access to the digital media. In some embodiments, a temporary preview or limited-access version of digital media may be provided prior to authorization.

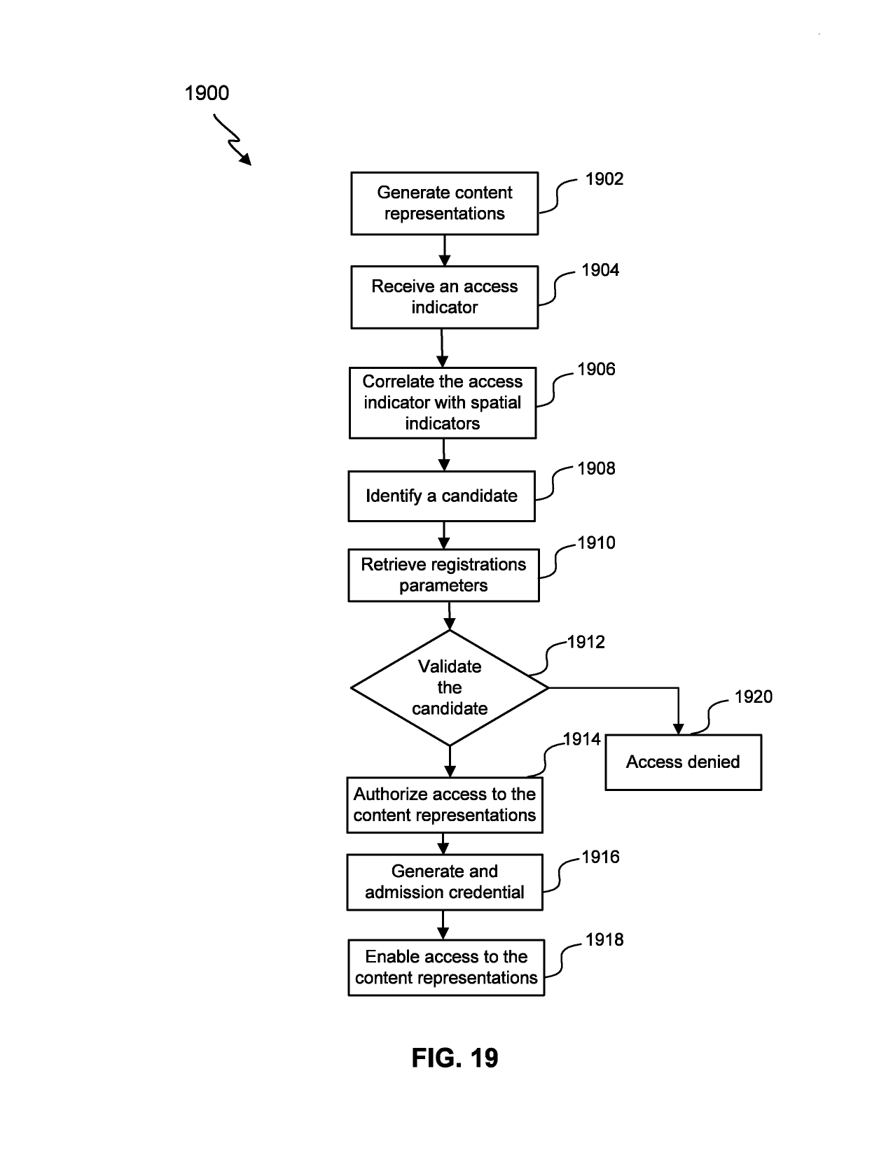

FIG. 19 illustrates a flowchart 1900 for controlling access to the content representations based on identity verification according to an embodiment of the present disclosure.

At step 1902, the content processing system 102 generates the content representations. The content processing system 102 comprises one or more processors. The content representations may include images, videos, professional photographs, or other digital media captured at the content source, such as an event venue. The generation process is performed using the metadata related to the content source and the spatial indicators corresponding to locations associated with the content source. The metadata may include tagged descriptors, such as event identifiers, timestamps, performer identifiers, session identifiers, or contextual labels, corresponding to the content source. The spatial indicators may include venue zones, venue sections, seat locations, seating sections, stage proximity, aisle mapping, camera capture position, or device location at the time of capture. In some embodiments, the content representations are indexed and stored within the cloud-based content repository in association with the metadata and the spatial indicators to enable structured retrieval.

At step 1904, the content processing system 102 receives an access indicator corresponding to a request to access the set of content representations. The access indicator may be generated via the user device 104 in response to user interaction, scanning of an identifier, biometric input, facial recognition trigger, or initiation of a content access request through an application interface. The access indicator is transmitted to the content processing system 102 over the data communication network(s) 114 for further processing.

At step 1906, the content processing system 102 correlates the received access indicator with at least one of the spatial indicators associated with the stored content representations. The correlation may include matching geolocation data, seating information, device capture position, time-of-access data, or other contextual attributes with corresponding spatial metadata indexed within the content repository. The correlation narrows a candidate pool of content representations potentially associated with the requesting user.

At step 1908, based on the spatial correlation, an identity validation engine identifies a candidate corresponding to the request. The candidate may represent a registered user profile, subscribed profile, or previously enrolled identity associated with stored registration information.

At step 1910, the content processing system 102 retrieves registration parameters associated with the identified candidate. The registration parameters may include stored reference images, biometric templates, user credentials, subscription attributes, device associations, historical access activity, or predefined access policies associated with the candidate profile.

At step 1912, the candidate is validated using a machine-learning model configured to evaluate visual features and contextual attributes associated with the candidate. In an exemplary embodiment, the machine-learning model may include a facial recognition model configured to extract visual features from input images received as part of the access indicator and compare them with stored reference features associated with the candidate to generate a similarity score. The validation process may additionally evaluate contextual attributes, such as device metadata, geolocation consistency, time-of-access alignment, network identifiers, and historical usage patterns to generate a validation outcome or similarity score indicative of identity authenticity.

At step 1914, the access controller 416 authorizes access to the content representations based on the validation of the candidate and the retrieved registration parameters. Authorization may further incorporate evaluation of predefined access policies, subscription status, time-based restrictions, or content-specific permissions. If the validation satisfies predefined confidence thresholds and policy conditions, the candidate is deemed authorized. For instance, when the similarity score exceeds a predefined confidence threshold indicative of a verified identity match, the candidate is deemed authorized.

At step 1916, upon successful authorization, the content processing system 102 generates an admission credential. The admission credential may comprise a secure digital token, encrypted session key, cryptographically signed pointer, or time-bound access certificate. In some embodiments, the admission credential is cryptographically associated with specific content representations and the authorized candidate profile to prevent unauthorized reuse or duplication.

At step 1918, access to the content representations is enabled using the generated admission credential. The admission credential is verified by the cloud-based content repository prior to granting access. Upon verification, the authorized user is permitted to view, download, or otherwise interact with the content representations in accordance with the access policies. In some embodiments, the access may be device-bound, geo-restricted, session-limited, or time-restricted based on parameters encoded within the admission credential.

If validation at step 1912 fails or authorization conditions at step 1914 are not satisfied, access to the set of content representations is denied as shown by step 1920. The content processing system 102 may prompt the user 106 to reattempt identity verification, update registration parameters, or request subscription authorization before granting access.

In some embodiments, there are professional photographers when participating in an event, boarding a ship, etc. The professional photographers may capture some professional photographs. Those professional photographs can be presented with a frame, branding, logos, matting, etc., to better memorialize the event. Matching the user(s) with the photos for integration into the app permits customization and purchase. Mascot interactions could be provided, and photos taken.

To match the user 106 with the photos captured by the professional photographer, the ML model(s) 116 obtain the images of user 106 from either the user device 104 or the media channel(s) 108. Further, the ML model(s) 116 obtain the images captured by the professional photographer. The ML model(s) 116 extract features from the images of the user 106 and compare the features in the images captured by the professional photographer.

After getting a positive match between the image of the user 106 and the image captured by the professional photographer, the ML model(s) 116 select the images in which the user 106 is captured. Further, the content processing system 102 renders the images to the user 106 through the user device 104 for selecting the desired images by the user 106. In such a way, the present disclosure permits integration of the images captured by a third party into the frame for the user 106.

In an embodiment, there are some professional artists participating in events and festivals. These artists may construct professional artwork during the event. Those professional artworks can be presented to the user 106 for creating memories of the event. In such a way, the present disclosure permits integration of the artworks constructed by the artist into the frame personalized for the user 106.

In some embodiments, specific arrangements could merely be available to those who attended the event. Unshared photos or configurations could be limited to a lucky few. There could be integrations with memorabilia sellers, auction houses, etc. Certification agencies could be included to verify authenticity before delivery.

The content processing system 102 obtains data indicating the presence of user 106 in the event. Such data may include, but is not limited to, details of tickets from the event promoter server(s) 112, images showing presence of the user 106 in the event from the media channel(s) 108 or the database 110, and geolocation of the user 106 during the event. The users are identified using specific criteria. For example, if the user 106 has attended the event, the content processing system 102 enables the user 106 to access specific content related to the event. Other users who have not attended the event may be unable to access these contents.

In some embodiments, the event may have occurred a long time ago and is attended by the user 106. The content processing system 102 obtains images related to the event. Further, the content processing system 102 renders the images on the user device 104. The user 106 may select images from the options provided by the content processing system 102.

In some embodiments, the content processing system 102 avoids redundancy of the digital assets or digital media by synchronizing the content repository with the user database. The digital assets are stored in a centralized repository (content repository), while the user database maintains references to those digital assets in place of duplicate copies. Any update to the digital asset is reflected across both the content repository and the user database, ensuring storage efficiency and uniform access to the up-to-date version of the digital assets.

In some embodiments, access to the set of content representations may be enabled across multiple user device platforms, including iPhone® and Android™ devices, devoid of differentiation in access privileges or functionality. The content processing system 102 ensures that the admission credential and associated access policies are platform-agnostic, thereby allowing users 106 to authenticate and retrieve content representations using either operating system. Upon successful identity verification and authorization, the content processing system 102 renders the content representations through a compatible mobile application or web interface on the user device 104. Accordingly, whether the user 106 accesses the content processing system 102 via an iPhone® device or an Android™ device, the same secure access workflow, content availability, and user experience are maintained.

In some embodiments, the content processing system 102 prevents access when a static image or a forwarded picture of a content access pattern is used. The content processing system 102 validates real-time detection parameters, such as device context, session state, or dynamic verification signals, to ensure that the content access pattern is physically present and actively scanned or used, thereby restricting access through screenshots, shared images, or transmitted copies of the content access pattern over a device/phone/computer.

In some embodiments, the content processing system 102 performs multi-frame temporal consistency validation by analyzing sequential image frames captured during presentation of the access indicator to determine whether visual features exhibit natural temporal variations. The content processing system 102 evaluates motion continuity, micro-expression variation, and perspective shifts across frames to detect replay attacks involving static photographs, pre-recorded videos, or screen displays, thereby ensuring that the access indicator corresponds to a live and physically present user.

In some embodiments, the content processing system 102 performs environmental consistency validation by extracting environmental features from the captured image, including ambient lighting characteristics, background structure, and shadow orientation, and comparing them with expected environmental attributes associated with authorized access locations. The content processing system 102 determines whether the extracted environmental features satisfy a consistency threshold, thereby detecting spoofing attempts performed in simulated or manipulated environments.

In some embodiments, the content processing system 102 may determine whether a location associated with a user, device, or access request is valid or invalid based on predefined criteria, stored location profiles, or the set of policies. The valid location may include authorized geographic regions, registered premises, or previously verified locations, while any deviation may be classified as an invalid location. Further, the content processing system 102 may continuously monitor operational or geographical state of the article. In response to detecting a change in background status, the content processing system 102 may automatically generate and transmit a notification. The notification may be provided to the user to ensure awareness, enable validation, and support security, compliance, or access control enforcement.

In some embodiments, the content processing system 102 implements adaptive similarity thresholding. The similarity score required for granting access is dynamically adjusted based on contextual risk factors including device trust level, access frequency, access location, and historical authentication confidence levels. The adaptive thresholding mechanism increases validation strictness in high-risk scenarios and reduces false positives while maintaining security integrity.

In some embodiments, the content processing system 102 performs behavioral pattern correlation. Behavioral attributes including access timing patterns, access frequency, interaction duration, and device handling characteristics. The behavioral attributes are analyzed using a behavioral machine-learning model to generate a behavioral confidence score. The behavioral confidence score is combined with the similarity score to determine an overall authentication confidence level.

In some embodiments, the content processing system 102 generates and maintains a dynamic identity profile. Reference visual features associated with an authorized user are periodically updated based on successfully validated access attempts. In addition, location information associated with the authorized user, including geolocation coordinates, frequently accessed locations, and location consistency patterns, is also periodically updated and stored as part of the dynamic identity profile. The dynamic identity profile allows the content processing system 102 to accommodate gradual appearance changes and evolving location behavior patterns while preventing unauthorized identity substitution.

In some embodiments, the content processing system 102 enforces privacy-aware content segregation to prevent private photos associated with the primary user from being shared with secondary users, including friends, family members, or relatives. The content processing system 102 automatically classifies photos based on predefined privacy policies, identity association, content sensitivity parameters, or user-defined access rules. Based on the classification, the content processing system 102 dynamically determines which photos are eligible for display to the secondary users or other authorized users distinct from the primary user. Photos designated as private remain restricted to the primary user, while selectively authorized content is displayed to the secondary users in accordance with role-based, relationship-based, or policy-based access control mechanisms, thereby ensuring controlled and differentiated content visibility.

In some embodiments, the article may include various forms of tangible or digital items associated with a content source, such as a photo frame, merchandise, collectible objects, memorabilia, or authenticated artifacts. The article may serve as a physical or digital carrier for a content access pattern, enabling retrieval of associated digital assets, regardless of whether the article is decorative, functional, commemorative, or collectible in nature.

The content processing system 102 creates a frame based on the user input. For example, the frame may be created by customizing the content obtained based on the user input. Further, the content processing system 102 renders the frame with content selected by the user 106. In an embodiment, the frame is rendered on the display device 304. As illustrated in FIG. 8E, the element 836 is the final frame rendered on display device 304. The user 106 may confirm an order of the frame through the user device 104. After confirmation, the content processing system 102 provides the frame to a printing device (not illustrated) to print the frame.

In such a way, the user 106 brings fond memories of the past. An attendee or fan can design their frame in the same way with media, logos, pictures from the event.

The present disclosure can be integrated with a third-party application, such as Amazon. For such a purpose, the content processing system 102 is communicatively coupled with a server associated with the third-party application. The content processing system 102 may provide information related to the event and the users to the server associated with the third-party application.

In such a way, the application associated with the content processing system 102 is integrated into other applications. In an alternate embodiment, the application associated with the content processing system 102 may be executed independently on the user device 104. The teams, artists or even the framing company app could integrate with functionality of the application associated with the content processing system 102.

In some embodiments, the content processing system 102 provides an advertisement on a web page accessed by the user 106. The advertisement indicates an option to buy a frame including the content related to the event. There would be in-app ads to buy at the event. Additionally, knowing the web pages and social media would permit suggested framed experiences to follow the attendees.

The advertisement is suggested by the ML model(s) 116. For example, the ML model(s) 116 obtain content related to the event and may personalize the content according to the user’s preferences and characteristics. Further, the ML model(s) 116 render the personalized content on the web page accessed by the user 106 in form of an advertisement.

The user 106 may click on the advertisement to redirect to the application hosted by the content processing system 102. The user 106 may provide an order request for the frame including the content through the user device 104. The content processing system 102 provides the framed content to the user 106 based on the order request.

The present disclosure provides different options for the user to purchase items and/or articles related to the event seamlessly through an application hosted by the content processing system 102. The content processing system 102 provides immersive experience of the event and enables the user to memorize the particular moment of the event. In addition, the present disclosure provides a provision of getting a certificate of authenticity for every single article and/or item purchased from the content processing system 102.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail to avoid obscuring the embodiments.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, non-volatile, or other storage medium and is not to be limited to any memory or number of memories, or type of media upon which memory is stored.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes but is not limited to portable or fixed storage devices, optical storage devices, and/or various other storage mediums capable of storing that contain or carry instruction(s) and/or data. These machine-readable instructions may be stored on one or more machine-readable mediums, such as CD-ROMs or other type of optical disks, solid-state drives, tape cartridges, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Implementation of the techniques, blocks, steps and means described above may be done in many ways. For example, these techniques, blocks, steps, and means may be implemented in hardware, software, or a combination thereof. For a digital hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof. For analog circuits, they can be implemented with discreet components or using monolithic microwave integrated circuit (MMIC), radio frequency integrated circuit (RFIC), and/or micro electro-mechanical systems (MEMS) technologies.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Various aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to In the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A, B, and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

While the principles of the disclosure have been described above in connection with specific apparatuses and methods, it is to be clearly understood that this description is made only by way of example and not as limitation on the scope of the disclosure.

We claim:

1. A computer-implemented method for controlling access to a set of content representations based on identity verification, the method comprising:
generating, via one or more processors, the set of content representations based on metadata related to a content source and a plurality of spatial indicators corresponding to locations related to the content source, wherein the metadata includes tagged descriptors corresponding to the content source;
receiving an access indicator corresponding to a request to access the set of content representations, wherein the set of content representations is stored in a cloud-based content repository;
correlating the access indicator with at least one of the plurality of spatial indicators;
identifying a candidate based on the correlation;
retrieving registration parameters associated with the candidate;
validating the candidate using a machine-learning model configured to evaluate visual features and contextual attributes associated with the candidate;
authorizing access to the set of content representations based on the validation of the candidate and the registration parameters;
generating an admission credential in response to authorizing the access; and
enabling access to the set of content representations using the admission credential.

2. The computer-implemented method of claim 1, wherein the access indicator is generated in response to a detection of an identifier on an article, the article corresponding to the content source, and the identifier comprising at least one of a machine-readable code, a biometric input interface, and a facial recognition trigger.

3. The computer-implemented method of claim 1, further comprising:
comparing, by a facial recognition model, the visual features extracted from at least one image associated with the access indicator with a stored reference image associated with the candidate to generate a similarity score; and
generating the admission credential when the similarity score exceeds a predefined confidence threshold indicative of a verified identity match.

4. The computer-implemented method of claim 1, wherein:
the contextual attributes include at least one of device metadata, geolocation data, time-of-access information, network identifier, historical access activity, and spatial correlation data associated with the access indicator; and
the plurality of spatial indicators includes at least one of venue zone, venue sections, stage proximity, seat location, aisle mapping, camera capture position, and device location during generation of the set of content representations.

5. The computer-implemented method of claim 1, wherein the set of content representations corresponds to a plurality of digital assets, and comprises at least one of images, videos, and professional photographs captured at the content source, and wherein the cloud-based content repository is maintained for a subscribed profile.

6. The computer-implemented method of claim 1, further comprising cryptographically associating the admission credential with the set of content representations, such that the admission credential represents a secure digital pointer to the cloud-based content repository.

7. The computer-implemented method of claim 1, further comprising evaluating the access indicator against a plurality of access policies, wherein the plurality of access policies define one or more access conditions including at least one of unrestricted access, limited access, time-restricted access, content-specific access, and denied access, and wherein authorization is performed based on the evaluated access indicator.

8. A system for controlling access to a set of content representations based on identity verification, the system comprising:
a cloud-based content repository storing the set of content representations; and
one or more processors operationally coupled to the cloud-based content repository, wherein the one or more processors are configured to:
generate the set of content representations based on metadata related to a content source and a plurality of spatial indicators corresponding to locations related to the content source, wherein the metadata includes tagged descriptors corresponding to the content source;
receive an access indicator corresponding to a request to access the set of content representations, wherein the set of content representations is stored in the cloud-based content repository;
correlate the access indicator with at least one of the plurality of spatial indicators;
identify a candidate based on the correlation;
retrieve registration parameters associated with the candidate;
validate the candidate using a machine-learning model configured to evaluate visual features and contextual attributes associated with the candidate;
authorize access to the set of content representations based on the validation of the candidate and the registration parameters;
generate an admission credential in response to authorizing the access; and
enable access to the set of content representations using the admission credential.

9. The system of claim 8, wherein the access indicator is generated in response to a detection of an identifier on an article, the article corresponding to the content source, and the identifier comprising at least one of a machine-readable code, a biometric input interface, and a facial recognition trigger.

10. The system of claim 8, wherein the one or more processors are further configured to:
compare, by a facial recognition model, the visual features extracted from at least one image associated with the access indicator with a stored reference image associated with the candidate to generate a similarity score; and
generate the admission credential when the similarity score exceeds a predefined confidence threshold indicative of a verified identity match.

11. The system of claim 8, wherein:
the contextual attributes include at least one of device metadata, geolocation data, time-of-access information, network identifier, historical access activity, and spatial correlation data associated with the access indicator; and
the plurality of spatial indicators includes at least one of venue zone, venue sections, stage proximity, seat location, aisle mapping, camera capture position, and device location during generation of the set of content representations.

12. The system of claim 8, wherein the set of content representations corresponds to a plurality of digital assets, and comprises at least one of images, videos, and professional photographs captured at the content source, and wherein the cloud-based content repository is maintained for a subscribed profile.

13. The system of claim 8, wherein the one or more processors are further configured to cryptographically associate the admission credential with the set of content representations, such that the admission credential represents a secure digital pointer to the cloud-based content repository.

14. The system of claim 8, wherein the one or more processors are further configured to evaluate the access indicator against a plurality of access policies, wherein the plurality of access policies define one or more access conditions including at least one of unrestricted access, limited access, time-restricted access, content-specific access, or denied access, and wherein authorization is performed based on the evaluated access indicator.

15. A non-transitory computer-readable medium storing instructions that, when executed by one or more processors, cause the one or more processors to perform a method for controlling access to a set of content representations based on identity verification, the method comprising:
generating, via the one or more processors, the set of content representations based on metadata related to a content source and a plurality of spatial indicators corresponding to locations related to the content source, wherein the metadata includes tagged descriptors corresponding to the content source;
receiving an access indicator corresponding to a request to access the set of content representations, wherein the set of content representations is stored in a cloud-based content repository;
correlating the access indicator with at least one of the plurality of spatial indicators;
identifying a candidate based on the correlation;
retrieving registration parameters associated with the candidate;
validating the candidate using a machine-learning model configured to evaluate visual features and contextual attributes associated with the candidate;
authorizing access to the set of content representations based on the validation of the candidate and the registration parameters;
generating an admission credential in response to authorizing the access; and
enabling access to the set of content representations using the admission credential.

16. The non-transitory computer-readable medium of claim 15, wherein the access indicator is generated in response to a detection of an identifier on an article, the article corresponding to the content source, and the identifier comprising at least one of a machine-readable code, a biometric input interface, and a facial recognition trigger.

17. The non-transitory computer-readable medium of claim 15, wherein the method further comprises:
compare, by a facial recognition model, the visual features extracted from at least one image associated with the access indicator with a stored reference image associated with the candidate to generate a similarity score; and
generating the admission credential when the similarity score exceeds a predefined confidence threshold indicative of a verified identity match.

18. The non-transitory computer-readable medium of claim 15, wherein:
the contextual attributes include at least one of device metadata, geolocation data, time-of-access information, network identifier, historical access activity, and spatial correlation data associated with the access indicator; and
the plurality of spatial indicators includes at least one of venue zone, venue sections, stage proximity, seat location, aisle mapping, camera capture position, and device location during generation of the set of content representations.

19. The non-transitory computer-readable medium of claim 15, wherein the set of content representations corresponds to a plurality of digital assets, and comprises at least one of images, videos, and professional photographs captured at the content source, and wherein the cloud-based content repository is maintained for a subscribed profile.

20. The non-transitory computer-readable medium of claim 15, wherein the method further comprises:
cryptographically associating the admission credential with the set of content representations, such that the admission credential represents a secure digital pointer to the cloud-based content repository.
